(19) United States
(12) Patent Application Publication
(10) Pub. No.: US 2019/0044187 A1
(43) Pub. Date: Feb. 7, 2019

(54) ELECTROLYTIC SOLUTION

(71) Applicant: THE UNIVERSITY OF TOKYO, Tokyo (JP)

(72) Inventors: Yuki HASEGAWA, Kariya-shi (JP); Tomoyuki KAWAI, Kariya-shi (JP)

(73) Assignee: THE UNIVERSITY OF TOKYO, Tokyo (JP)

(21) Appl. No.: 16/078,198

(22) PCT Filed: Feb. 1, 2017
(86) PCT No.: PCT/JP2017/003534

§ 371 Date: Aug. 21, 2018

(30) Foreign Application Priority Data
Feb. 26, 2016 (JP) 2016-036143

(51) Int. Cl. H01M 10/0569; H01M 10/0568; H01M 10/0525; H01M 4/133; H01M 4/62

(52) U.S. Cl. CPC H01M 10/0569; H01M 10/0568; H01M 10/0525; H01M 4/662; H01M 4/622; H01M 2300/0037; H01M 4/133

(57) ABSTRACT

An electrolytic solution containing:
a lithium salt; and
dimethyl carbonate serving as a first heteroelement-containing organic solvent, and ethyl methyl carbonate and/or diethyl carbonate serving as a second heteroelement-containing organic solvent, wherein
a total mole ratio Y of the first heteroelement-containing organic solvent and the second heteroelement-containing organic solvent relative to the lithium salt satisfies 5≤Y≤8, and
when a mole ratio of the second heteroelement-containing organic solvent relative to total moles of the first heteroelement-containing organic solvent and the second heteroelement-containing organic solvent is defined as X, the mole ratio X and the mole ratio Y satisfy an inequality below

Y≤AX+B(where 1.8≤A≤3.4 and 3.5≤B≤4.9).

### TECHNICAL FIELD

The present invention relates to an electrolytic solution to be used in power storage devices such as secondary batteries.

### BACKGROUND ART

Generally, a power storage device such as a secondary battery includes, as main components, a positive electrode, a negative electrode, and an electrolytic solution. In the electrolytic solution, an appropriate electrolyte is added in an appropriate concentration range. For example, in an electrolytic solution of a lithium ion secondary battery, a lithium salt such as LiClO₄, LiAsF₆, LiPF₆, LiBF₄, CF₃SO₃Li, and (CF₃SO₂)₂NLi is generally added as an electrolyte, and the concentration of the lithium salt in the electrolytic solution is generally set at about 1 mol/L.

In an organic solvent to be used in an electrolytic solution, a cyclic carbonate such as ethylene carbonate or propylene carbonate is generally mixed by not less than about 30 vol %, in order to suitably dissolve an electrolyte.

In fact, Patent Literature 1 discloses a lithium ion secondary battery using an electrolytic solution that uses a mixed organic solvent containing ethylene carbonate by 33 vol % and that contains LiPF₆ at a concentration of 1 mol/L. Furthermore, Patent Literature 2 discloses a lithium ion secondary battery using an electrolytic solution that uses a mixed organic solvent containing ethylene carbonate and propylene carbonate by 66 vol and that contains (CF₃SO₂)₂NLi at a concentration of 1 mol/L.

For the purpose of improving performance of secondary batteries, studies are actively conducted for adding various additives to an electrolytic solution containing a lithium salt.

For example, Patent Literature 3 describes an electrolytic solution obtained by adding a small amount of a specific additive to an electrolytic solution that uses a mixed organic solvent containing ethylene carbonate by 30 vol % and that contains LiPF₆ at a concentration of 1 mol/L. Patent Literature 3 discloses a lithium ion secondary battery using this electrolytic solution.

Furthermore, Patent Literature 4 describes an electrolytic solution obtained by adding a small amount of phenyl glycidyl ether to a solution that uses a mixed organic solvent containing ethylene carbonate by 30 vol % and that contains LiPF_{G} at a concentration of 1 mol/L. Patent Literature 4 discloses a lithium ion secondary battery using this electrolytic solution.

As described in Patent Literature 1 to 4, conventionally, as for an electrolytic solution used in a lithium ion secondary battery, using a mixed organic solvent that contains, by not less than about 30 vol %, an organic solvent having a high relative permittivity and a high dipole moment such as ethylene carbonate or propylene carbonate and causing a lithium salt to be contained at a concentration of about 1 mol/L were common technical knowledge. In addition, as described in Patent Literature 3 and 4, studies for improving electrolytic solutions have been generally conducted with a focus on additives, which are separate components from the lithium salt.

Different from the focus of persons skilled in the art in the art hitherto, the present inventors conducted studies with a focus on an electrolytic solution which contains a metal salt at a high concentration and in which the metal salt and an organic solvent exist in a new state, and reported the result in Patent Literature 5.

Further, the present inventors found that an electrolytic solution containing a specific organic solvent at a mole ratio of 3-5 relative to a specific metal salt was suitable, and reported the result in Patent Literature 6.

### CITATION LIST

### Patent Literature

Patent Literature 1: JP 2013-149477 (A)

Patent Literature 2: JP 2013-134922 (A)

Patent Literature 3: JP 2013-145724 (A)

Patent Literature 4: JP 2013-137873 (A)

Patent Literature 5: WO 2015/045389

Patent Literature 6: WO 2016/063468

### SUMMARY OF INVENTION

### Technical Problem

Meanwhile, in industrial fields, high-performance lithium ion secondary batteries usable in various environments are demanded. In order to provide such high performance lithium ion secondary batteries, studies of components thereof are actively conducted.

The present invention has been made in consideration of such circumstances. An object of the present invention is to provide an electrolytic solution that exhibits an excellent ionic conductivity. Another object of the present invention is to provide an electrolytic solution that suitably operates in a low-temperature environment. Still another object of the present invention is to provide a lithium ion secondary battery that exhibits excellent input-output characteristics and durability.

### Solution to Problem

The present inventors conducted thorough investigation with much trial and error, and found an electrolytic solution exhibiting an ionic conductivity equivalent to or higher than the ionic conductivity of the electrolytic solution having a mole ratio of 3-5 reported in Patent Literature 6. In addition, when the present inventors advanced the study of an electrolytic solution using a plurality of types of organic solvents, the present inventors found that, with respect to the characteristics of the electrolytic solution at low temperature, the mole ratio of an organic solvent relative to an electrolyte and the mole ratio of a mixture of a plurality of types of organic solvents exhibit a linear relationship. On the basis of these findings, the present inventors completed the present invention.

An electrolytic solution of the present invention is an electrolytic solution containing a lithium salt and a heteroelement-containing organic solvent, wherein a mole ratio Y of the heteroelement-containing organic solvent relative to the lithium salt satisfies

A suitable mode of an electrolytic solution of the present invention is an electrolytic solution containing a lithium salt and a heteroelement-containing organic solvent, wherein a mole ratio Y of the heteroelement-containing organic solvent relative to the lithium salt satisfies 5≤Y≤8,

the heteroelement-containing organic solvent includes a first heteroelement-containing organic solvent and a second heteroelement-containing organic solvent,

when the mole ratio of the second heteroelement-containing organic solvent relative to the total moles of the first heteroelement-containing organic solvent and the second heteroelement-containing organic solvent is defined as X, the mole ratio X and the mole ratio Y satisfy an inequality below

Y≤AX+B(where 1.8≤A≤3.4 and 3.5≤B≤4.9).

### Advantageous Effects of Invention

The electrolytic solution of the present invention exhibits a suitable ionic conductivity. In a suitable mode of the electrolytic solution of the present invention, the electrolytic solution is less likely to solidify even at low temperature, and suitably functions as an electrolytic solution of a lithium ion secondary battery.

### BRIEF DESCRIPTION OF DRAWINGS

FIG. 1 is a graph showing results obtained in Evaluation Example 1;

FIG. 2 is a graph obtained by plotting the results shown in Table 6-10 and Table 6-11;

FIG. 3 is a graph obtained by plotting the results shown in Table 6-14;

FIG. 4 is a graph obtained by plotting the results shown in Table 6-16 and Table 6-17;

FIG. 5 is a graph obtained by plotting the results shown in Table 6-20;

FIG. 6 is a graph showing the relationship between potential (3.1 V to 4.2 V) and response current in the half-cell of Example A-1;

FIG. 7 is a graph showing the relationship between potential (3.1 V to 4.6 V) and response current in the half-cell of Example A-1;

FIG. 8 is a graph showing the relationship between potential (3.1 V to 4.2 V) and response current in the half-cell of Example A-2;

FIG. 9 is a graph showing the relationship between potential (3.1 V to 4.6 V) and response current in the half-cell of Example A-2;

FIG. 10 is a graph showing the relationship between potential (3.1 V to 4.2 V) and response current in the half-cell of Example B-1;

FIG. 11 is a graph showing the relationship between potential (3.1 V to 4.6 V) and response current in the half-cell of Example B-1;

FIG. 12 is a graph showing the relationship between potential (3.1 V to 4.2 V) and response current in the half-cell of Example B-2;

FIG. 13 is a graph showing the relationship between potential (3.1 V to 4.6 V) and response current in the half-cell of Example B-2;

FIG. 14 is a graph showing the relationship between potential (3.1 V to 4.2 V) and response current in the half-cell of Example C-1;

FIG. 15 is a graph showing the relationship between potential (3.1 V to 4.6 V) and response current in the half-cell of Example C-1;

FIG. 16 is a graph showing the relationship between potential (3.1 V to 4.2 V) and response current in the half-cell of Example C-2; and

FIG. 17 is a graph showing the relationship between potential (3.1 V to 4.6 V) and response current in the half-cell of Example C-2.

### DESCRIPTION OF EMBODIMENTS

The following describes embodiments of the present invention. Unless mentioned otherwise in particular, a numerical value range of “a to b (or, a-b)” described in the present specification includes, in the range thereof, a lower limit “a” and an upper limit “b”. A numerical value range is formed by arbitrarily combining such upper limit values, lower limit values, and numerical values described in Examples. In addition, numerical values arbitrarily selected within a numerical value range may be used as upper limit and lower limit numerical values.

An electrolytic solution of the present invention is an electrolytic solution containing a lithium salt and a heteroelement-containing organic solvent, wherein a mole ratio Y of the organic solvent relative to the lithium salt satisfies 5≤Y≤8.

Examples of the lithium salt include compounds each represented by the general formula (1) below (hereinafter, also referred to as “imide salt”), LiXO₄, LiAsX₆, LiPX₆, LiBX₄, and LiB(C₂O₄)₂. Here, each X independently means a halogen or CN. X is selected from F, Cl, Br, I, or CN, as appropriate. Suitable examples of LiXO₄, LiAsX₆, LiPX₆, and LiBX₄ include LiClO₄, LiAsF₆, LiPF₆, LiBF₄, and LiBF_{y}(CN) z (y is an integer from 0 to 3, z is an integer from 1 to 4, and y and z satisfy y+z=4).

(R¹X¹)(R²SO₂)NLi general formula (1)

(R¹ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

R² is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

R¹ and R² optionally bind with each other to form a ring.

X¹ is selected from SO₂, C═O, C═S, R^{a}P═O, R^{b}P═S, S═O, or Si═O.

R^{a} and R_{b} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

R^{a} and R^{b} each optionally bind with T¹ or R² to form a ring.)

The wording “optionally substituted with a substituent group” in the chemical structures represented by the above described general formula (1) is to be described. For example, “an alkyl group optionally substituted with a substituent group” refers to an alkyl group in which one or more hydrogen atoms of the alkyl group is substituted with a substituent group, or an alkyl group not including any particular substituent groups.

Examples of the substituent group in the wording “optionally substituted with a substituent group” include alkyl groups, alkenyl groups, alkynyl groups, cycloalkyl groups, unsaturated cycloalkyl groups, aromatic groups, heterocyclic groups, halogens, OH, SH, CN, SCN, OCN, nitro group, alkoxy groups, unsaturated alkoxy groups, amino group, alkylamino groups, dialkylamino groups, aryloxy groups, acyl groups, alkoxycarbonyl groups, acyloxy groups, aryloxycarbonyl groups, acylamino groups, alkoxycarbonylamino groups, aryloxycarbonylamino groups, sulfonyl amino groups, sulfamoyl groups, carbamoyl group, alkylthio groups, arylthio groups, sulfonyl group, sulfinyl group, ureido groups, phosphoric acid amide groups, sulfo group, carboxyl group, hydroxamic acid groups, sulfino group, hydrazino group, imino group, silyl group, etc. These substituent groups may be further substituted. In addition, when two or more substituent groups exist, the substituent groups may be identical or different from each other.

Among the lithium salts, imide salts are preferable. The reason is as follows.

An anion of LiXO₄, LiAsX₆, LiPX₆, LiBX₄, or LiB(C₂O₄)₂ has a regular tetrahedron structure or a regular octahedron structure having other elements as vertexes while having X, As, P, or B at the center, or a structure in which B is chelated with two bidentate ligands. The structure of these anions is stabilized with four or six bonds with respect to the center element, and has high symmetry. Thus, each of these lithium salts easily forms a regular crystal structure. That is, an electrolytic solution using such a lithium salt is considered to be easily crystallized in a high concentration condition or a low temperature condition, and further, in a case where an organic solvent having a relatively small permittivity and having a low dissociability of a Li salt is used as an electrolytic solution solvent.

Meanwhile, an anion of an imide salt has two bonds having N at the center, and is easy to be deformed and has low symmetry when compared with an anion of LiPX₆ or the like described above. In addition, an anion of an imide salt has a large molecular size and a relatively small charge density on the surface. Thus, a combination of an anion of an imide and a lithium cation having a small cation size and a high charge density is considered to be disadvantageous in forming a salt and a crystal. Therefore, an imide salt requires relatively large crystallization energy for crystallization, and thus, an electrolytic solution using an imide salt as a lithium salt is considered to be less likely to be crystallized even in a high concentration condition or a low temperature condition, and further, in a case where an organic solvent having a relatively small permittivity and having a low dissociability of a Li salt is used as an electrolytic solution solvent.

Regarding the lithium salt in the electrolytic solution of the present invention, a single type may be used, or a combination of two or more types may be used.

In the electrolytic solution of the present invention, the imide salt is contained, relative to the entire lithium salt, by preferably not less than 50 mass % or not less than 50 mole %, more preferably not less than 70 mass % or not less than 70 mole %, further preferably not less than 90 mass % or not less than 90 mole %, and particularly preferably not less than 95 mass % or not less than 95 mole %. Most preferably, all of the lithium salt is the imide salt.

Preferably, the imide salt is represented by general formula (1-1) below.

(R³X²)(R⁴SO₂)NLi general formula (1-1)

(R³ and R⁴ are each independently CₙHₐF_{b}Cl_{c}Br_{d}Iₑ(CN)_{f}(SCN)_{g} (OCN)ₕ.

“n”, “a”, “b”, “c”, “d”, “e”, “f”, “g”, and “h” are each independently an integer not smaller than 0, and satisfy 2n+1=a+b+c+d+e+f+g+h.

R³ and R⁴ optionally bind with each other to form a ring, and, in that case, satisfy 2n=a+b+c+d+e+f+g+h.

X² is selected from SO₂, C═O, C═S, R^{c}P═O, R^{d}P═S, S═O, or Si═O.

R^{c} and R^{d} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

R^{c} and R^{d} each optionally bind with R³ or R⁴ to form a ring.)

In the chemical structure represented by the general formula (1-1), the meaning of the wording “optionally substituted with a substituent group” is synonymous with that described for the general formula (1).

In the chemical structure represented by the general formula (1-1), “n” is preferably an integer from 0 to 6, more preferably an integer from 0 to 4, and particularly preferably an integer from 0 to 2. In the chemical structure represented by the general formula (1-1), when R³ and R⁴ bind with each other to form a ring, “n” is preferably an integer from 1 to 8, more preferably an integer from 1 to 7, and particularly preferably an integer from 1 to 3.

Further preferably, the imide salt is represented by general formula (1-2) below.

(R⁵SO₂)(R⁶SO₂)NLi general formula (1-2)

(R⁵ and R⁶ are each independently CₙHₐF_{b}Cl_{c}Br_{d}Iₑ.

“n”, “a”, “b”, “c”, “d”, and “e” are each independently an integer not smaller than 0, and satisfy 2n+1=a+b+c+d+e.

R⁵ and R⁶ optionally bind with each other to form a ring, and, in that case, satisfy 2n=a+b+c+d+e.).

In the chemical structure represented by the general formula (1-2), “n” is preferably an integer from 0 to 6, more preferably an integer from 0 to 4, and particularly preferably an integer from 0 to 2. In the chemical structure represented by the general formula (1-2), when R⁵ and R⁶ bind with each other to form a ring, “n” is preferably an integer from 1 to 8, more preferably an integer from 1 to 7, and particularly preferably an integer from 1 to 3.

In addition, in the chemical structure represented by the general formula (1-2), those in which “a,” “c,” “d,” and “e” are 0 are preferable.

The imide salt is particularly preferably (CF₃SO₂)₂NLi (hereinafter, sometimes referred to as “LiTFSA”), (FSO₂)₂NLi (hereinafter, sometimes referred to as “LiFSA”), (C₂F₅SO₂)₂NLi, FSO₂ (CF₃SO₂) NLi(SO₂CF₂CF₂SO₂)NLi, (SO₂CF₂CF₂CF₂SO₂)NLi, FSO₂ (CH₃SO₂)NLi, FSO₂(C₂F₅SO₂) NLi, or FSO₂(C₂H₅SO₂) NLi

As the heteroelement-containing organic solvent, an organic solvent whose heteroelement is at least one selected from nitrogen, oxygen, sulfur, and halogen is preferable and an organic solvent whose heteroelement is oxygen is more preferable. In addition, as the heteroelement-containing organic solvent, an aprotic solvent not having a proton donor group such as NH group, NH₂ group, OH group, and SH group is preferable.

Specific examples of the heteroelement-containing organic solvent include linear carbonates represented by general formula (2) below (hereinafter, also simplyreferredto as “linear carbonate”), nitriles such as acetonitrile, propionitrile, acrylonitrile, and malononitrile, ethers such as 1,2-dimethoxyethane, 1,2-diethoxyethane, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, and crown ethers, cyclic carbonates such as ethylene carbonate and propylene carbonate, amides such as formamide, N,N-dimethylformamide, N,N-dimethylacetamide, and N-methylpyrrolidone, isocyanates such as isopropyl isocyanate, n-propylisocyanate, and chloromethyl isocyanate, esters such as methyl acetate, ethyl acetate, propyl acetate, butyl acetate, methyl propionate, methyl formate, ethyl formate, vinyl acetate, methyl acrylate, and methyl methacrylate, epoxies such as glycidyl methyl ether, epoxy butane, and 2-ethyloxirane, oxazoles such as oxazole, 2-ethyloxazole, oxazoline, and 2-methyl-2-oxazoline, ketones such as acetone, methyl ethyl ketone, and methyl isobutyl ketone, acid anhydrides such as acetic anhydride and propionic anhydride, sulfones such as dimethyl sulfone and sulfolane, sulfoxides such as dimethyl sulfoxide, nitros such as 1-nitropropane and 2-nitropropane, furans such as furan and furfural, cyclic esters such as γ-butyrolactone, γ-valerolactone, and 6-valerolactone, aromatic heterocycles such as thiophene and pyridine, heterocycles such as tetrahydro-4-pyrone, 1-methylpyrrolidine, and N-methylmorpholine, and phosphoric acid esters such as trimethyl phosphate and triethyl phosphate.

R²⁰OCOOR²¹ general formula (2)

(R²⁰ and R²¹ are each independently selected from CₙHₐF_{b}Cl_{c}Br_{d}Iₑ that is a linear alkyl, or CₘH_{f}F_{g}ClₕBrᵢIⱼ that includes a cyclic alkyl in the chemical structure thereof. “n” is an integer not smaller than 1, “m” is an integer not smaller than 3, and “a”, “b”, “c”, “d”, “e”, “f”, “g”, “h”, “i”, and “j” are each independently an integer not smaller than 0, and satisfy 2n+1=a+b+c+d+e and 2m−1=f+g+h+i+j.)

In the linear carbonates represented by the general formula (2), “n” is preferably an integer from 1 to 6, more preferably an integer from 1 to 4, and particularly preferably an integer from 1 to 2. “m” is preferably an integer from 3 to 8, more preferably an integer from 4 to 7, and particularly preferably an integer from 5 to 6.

Among the linear carbonates represented by the general formula (2), those represented by general formula (2-1) below are particularly preferable.

R²²OCOOR²³ general formula (2-1)

(R²² and R²³ are each independently selected from CₙHₐF_{b} that is a linear alkyl, or CₘH_{f}F_{g} that includes a cyclic alkyl in the chemical structure thereof. “n” is an integer not smaller than 1, “m” is an integer not smaller than 3, and “a”, “b”, “f”, and “g” are each independently an integer not smaller than 0, and satisfy 2n+1=a+b and 2m−1=f+g.)

In the linear carbonates represented by the general formula (2-1), “n” is preferably an integer from 1 to 6, more preferably an integer from 1 to 4, and particularly preferably an integer from 1 to 2. “m” is preferably an integer from 3 to 8, more preferably an integer from 4 to 7, and particularly preferably an integer from 5 to 6.

Among the linear carbonates represented by the general formula (2-1), dimethyl carbonate (hereinafter, sometimes referred to as “DMC”), diethyl carbonate (hereinafter, sometimes referred to as “DEC”), ethyl methyl carbonate (hereinafter, sometimes referred to as “EMC”), fluoromethyl methyl carbonate, difluoromethyl methyl carbonate, trifluoromethyl methyl carbonate, bis(fluoromethyl) carbonate, bis (difluoromethyl) carbonate, bis (trifluoromethyl) carbonate, fluoromethyl difluoromethyl carbonate, 2,2,2-trifluoroethyl methyl carbonate, pentafluoroethyl methyl carbonate, ethyl trifluoromethyl carbonate, and bis(2,2,2-trifluoroethyl) carbonate are particularly preferable.

Examples of suitable heteroelement-containing organic solvents include a heteroelement-containing organic solvent having a relative permittivity not greater than 10 (hereinafter, also referred to as “low permittivity solvent”). The affinity between the low permittivity solvent and metal ions is considered to be inferior compared to the affinity between a heteroelement-containing organic solvent having a relative permittivity greater than 10 and metal ions. Then, aluminum ora transition metal forming an electrode of the secondary battery is considered to be less likely to dissolve as ions into the low permittivity solvent.

In the electrolytic solution of the present invention, the low permittivity solvent is contained, relative to the entire heteroelement-containing organic solvent, by preferably not less than 90 vol % or not less than 90 mole %, and more preferably not less than 95 vol or not less than 95 mole %. Most preferably, all of the heteroelement-containing organic solvent is the low permittivity solvent.

The relative permittivity of the low permittivity solvent is preferably not greater than 10, more preferably not greater than 7, and further preferably not greater than 5. The lower limit of the relative permittivity of the low permittivity solvent is not limited in particular, but if such a lower limit is to be shown, examples thereof include not less than 1, not less than 2, and not less than 2.5.

As a reference, the relative permittivity of various types of organic solvents are listed in Table 1.

TABLE 1

| | Relative |
|---|---|
| Organic solvent | permittivity |
| dimethyl carbonate | 3.1 |
| diethyl carbonate | 2.8 |
| ethyl methyl carbonate | 3.0 |
| 1,2-dimethoxyethane | 7.2 |
| tetrahydrofuran | 7.5 |
| acetonitrile | 36 |
| methanol | 33 |
| acetone | 21 |
| ethylene carbonate | 90 |
| propylene carbonate | 65 |

Regarding the heteroelement-containing organic solvent described above, a single type may be used by itself in the electrolytic solution, or a combination of a plurality of types may be used. Particularly preferable examples of the heteroelement-containing organic solvent include one type, two types, and three types selected from DMC, DEC, and EMC.

In the electrolytic solution of the present invention, the linear carbonate is contained, relative to the entire heteroelement-containing organic solvent, by preferably not less than 90 vol %, not less than 90 mass %, or not less than 90 mole %, and more preferably not less than 95 vol %, not less than 95 mass %, or not less than 95 mole %. Most preferably, all of the heteroelement-containing organic solvent is the linear carbonate.

In many cases, the linear carbonate has a lower polarity than the heteroelement-containing organic solvent other than the linear carbonate. Therefore, the affinity between the linear carbonate and metal ions is considered to be relatively low. Then, when a suitable electrolytic solution of the present invention containing the linear carbonate by a large amount is used as the electrolytic solution of a secondary battery, aluminum or a transition metal forming an electrode of the secondary battery is considered to be less likely to dissolve as ions into the electrolytic solution.

Here, with respect to a secondary battery using a general electrolytic solution, a possible case is known in which: aluminum or a transition metal forming the positive electrode enters a high oxidation state especially in a high-voltage charging environment, and dissolves (anode elution) in the form of metal ions, which are positive ions, into the electrolytic solution; and then, the metal ions eluted in the electrolytic solution are attracted to the electron-rich negative electrode due to electrostatic attraction, to bind with electrons on the negative electrode, thereby to be reduced and deposited in the form of metal. If such a reaction occurs, performance of the battery is known to be reduced due to possible occurrence of decrease in the capacity of the positive electrode, degradation of the electrolytic solution on the negative electrode, and the like. However, the suitable electrolytic solution of the present invention containing the linear carbonate by a large amount has the features described in the former paragraphs, and thus, in a secondary battery using the electrolytic solution of the present invention, metal ion elution from the positive electrode and metal deposition on the negative electrode are suppressed.

Needless to say, an electrolytic solution obtained by combining a suitable lithium salt and a suitable heteroelement-containing organic solvent becomes more suitable.

In the electrolytic solution of the present invention, the mole ratio Y of the heteroelement-containing organic solvent relative to the lithium salt satisfies 5≤Y≤8. If the mole ratio Y is in the above-described range, the ionic conductivity of the electrolytic solution becomes suitable. The mole ratio Y satisfies preferably 5≤Y≤7, and more preferably 5≤Y≤6. In relation to Patent Literature 6, the lower limit of the mole ratio Y may be specified as satisfying 5<Y.

Too large a mole ratio Y leads to: a risk of decrease in the ionic conductivity of the electrolytic solution; a risk of causing a metal of a current collector and a transition metal forming an active material to be eluted into the electrolytic solution; a risk of destabilizing a metal of a current collector; a risk of facilitating solidification of the electrolytic solution at low temperature; and a risk of, when a battery is charged and discharged with large current, causing shortage of the amount of ion supply by the electrolytic solution to the electrode, thus resulting in increase of so-called diffusion resistance.

A suitable mode of the electrolytic solution of the present invention is an electrolytic solution containing a lithium salt and a heteroelement-containing organic solvent, wherein

a mole ratio Y of the organic solvent relative to the lithium salt satisfies 5≤Y≤8,

the heteroelement-containing organic solvent includes a first heteroelement-containing organic solvent and a second heteroelement-containing organic solvent, and

when the mole ratio of the second heteroelement-containing organic solvent relative to the total moles of the first heteroelement-containing organic solvent and the second heteroelement-containing organic solvent is defined as X, the mole ratio X and the mole ratio Y satisfy the inequality below

Y≤AX+B (where 1.8≤A≤3.4 and 3.5≤B≤4.9).

The electrolytic solution of the present invention in which the mole ratio X and the mole ratio Y satisfy the above inequality is less likely to solidify even at low temperature.

As the first heteroelement-containing organic solvent, a single type may be selected from the heteroelement-containing organic solvents described above. Preferably, the first heteroelement-containing organic solvent is a linear carbonate. In terms of ionic conductivity, the first heteroelement-containing organic solvent is more preferably DMC, EMC, or DEC, further preferably DMC or EMC, and most preferably DMC.

As the second heteroelement-containing organic solvent, one or more types of solvents other than the first heteroelement-containing organic solvent may be selected from the heteroelement-containing organic solvents described above. Preferably, the second heteroelement-containing organic solvent is a linear carbonate. In terms of stability of the electrolytic solution at low temperature, the second heteroelement-containing organic solvent is preferably EMC and/or DEC.

More preferably, each of the first heteroelement-containing organic solvent and the second heteroelement-containing organic solvent is a linear carbonate. Further, particularly preferably, the first heteroelement-containing organic solvent and the second heteroelement-containing organic solvent are selected from DMC, DEC, and/or EMC.

The range of X is 0<X<1. When the first heteroelement-containing organic solvent is used as a main solvent, and the second heteroelement-containing organic solvent is used as a sub-solvent, the range of X is 0<X<0.5.

From the description of the present specification, one mode of the electrolytic solution of the present invention is understood as an electrolytic solution containing: a lithium salt; and a first heteroelement-containing organic solvent and a second heteroelement-containing organic solvent, wherein a total mole ratio Y of the first heteroelement-containing organic solvent and the second heteroelement-containing organic solvent relative to the lithium salt satisfies 5≤Y≤8.

Further, from the description of the present specification, another mode of the electrolytic solution of the present invention is understood as an electrolytic solution containing: a lithium salt; and a first heteroelement-containing organic solvent and a second heteroelement-containing organic solvent, wherein

when the mole ratio of the second heteroelement-containing organic solvent relative to the total moles of the first heteroelement-containing organic solvent and the second heteroelement-containing organic solvent is defined as X, and the total mole ratio of the first heteroelement-containing organic solvent and the second heteroelement-containing organic solvent relative to the lithium salt is defined as Y, the mole ratio X and the mole ratio Y satisfy the inequality below

Y≤AX+B (where 0<X<1, 0<Y, 1.8≤A≤3.4, and 3.5≤B≤4.9).

As a matter of course, the description of the present specification is incorporated into the description of each feature in each mode in the above two paragraphs. In each mode in the above two paragraphs, the first heteroelement-containing organic solvent and the second heteroelement-containing organic solvent are contained in total, relative to the entire heteroelement-containing organic solvent contained in the electrolytic solution, by preferably not less than 90 vol %, not less than 90 mass %, or not less than 90 mole %, and more preferably not less than 95 vol %, not less than 95 mass %, or not less than 95 mole %. Most preferably, all of the heteroelement-containing organic solvent is composed of the first heteroelement-containing organic solvent and the second heteroelement-containing organic solvent.

From the description of the present specification, each inequality below is also understood as the inequality satisfied by a suitable electrolytic solution of the present invention.

Y≤3.4X+4.9 (where 0<X<1 and 0<Y)

Y≤1.8X+3.5 (where 0<X<1 and 0<Y)

Y≤AX+B(where 0<X<1, 0<Y, 2.1≤A≤2.9, and 3.9≤B≤4.6)

Y≤2.9X+4.6 (where 0<X<1 and 0<Y)

Y≤2.1X+3.9 (where 0<X<1 and 0<Y)

Y≤2.4 X+4.3 (where 0<X<1 and 0<Y)

Y≤2.8X+4.0 (where 0<X<1 and 0<Y)

Y≤2.2X≤4.5 (where 0<X<1 and 0<Y)

Y≤2.7 X+3.9 (where 0<X<1 and 0<Y)

Y≤2.6X+4.3 (where 0<X<1 and 0<Y)

Y≤2.7X+4.2 (where 0<X<1 and 0<Y)

Y≤2.1X+4.6 (where 0<X<1 and 0<Y)

Y≤2.6X+4.0 (where 0<X<1 and 0<Y)

Y≤2.9X+4.0 (where 0<X<1 and 0<Y)

The existence proportion of the lithium salt in the electrolytic solution of the present invention is considered to be relatively high compared to that in conventional electrolytic solutions. Then, the environment in which the lithium salt and the organic solvent exist in the electrolytic solution of the present invention is considered to be different from that in conventional electrolytic solutions. Therefore, in a power storage device such as a secondary battery using the electrolytic solution of the present invention, improvement in lithium ion transportation rate in the electrolytic solution, improvement in reaction rate at the interface between an electrode and the electrolytic solution, mitigation of uneven distribution of lithium salt concentration of the electrolytic solution caused when the secondary battery undergoes high-rate charging and discharging, improvement in liquid retaining property of the electrolytic solution at an electrode interface, suppression of a so-called liquid run-out state of lacking electrolytic solution at an electrode interface, increase in the capacity of an electrical double layer, and the like are expected. Furthermore, in the electrolytic solution of the present invention, the vapor pressure of the organic solvent contained in the electrolytic solution becomes low. As a result, volatilization of the organic solvent from the electrolytic solution of the present invention is reduced.

The electrolytic solution of the present invention may contain, in addition to the heteroelement-containing organic solvent, an organic solvent formed from a hydrocarbon not having a heteroelement. In the electrolytic solution of the present invention, the heteroelement-containing organic solvent is contained, relative to the entire solvent contained in the electrolytic solution of the present invention, by preferably not less than 80 volt, more preferably not less than 90 vol %, and further preferably not less than 95 vol %. In addition, in the electrolytic solution of the present invention, the heteroelement-containing organic solvent is contained, relative to the entire solvent contained in the electrolytic solution of the present invention, by preferably not less than 80 mole %, more preferably not less than 90 mole %, and further preferably not less than 95 mole %.

The electrolytic solution of the present invention containing an organic solvent formed from the above-mentioned hydrocarbon in addition to the heteroelement-containing organic solvent is expected to have an effect that the viscosity thereof is reduced.

Specific examples of the organic solvent formed from the above-mentioned hydrocarbon include benzene, toluene, ethyl benzene, o-xylene, m-xylene, p-xylene, l-methylnaphthalene, hexane, heptane, and cyclohexane.

Further, a fire-resistant solvent may be added to the electrolytic solution of the present invention. By adding the fire-resistant solvent to the electrolytic solution of the present invention, safety of the electrolytic solution of the present invention is further enhanced. Examples of the fire-resistant solvent include halogen-based solvents such as carbon tetrachloride, tetrachloroethane, and hydrofluoroether, and phosphoric acid derivatives such as trimethyl phosphate and triethyl phosphate.

When the electrolytic solution of the present invention is mixed with a polymer or an inorganic filler to form a mixture, the mixture enables containment of the electrolytic solution to provide a pseudo solid electrolyte. By using the pseudo solid electrolyte as an electrolytic solution of a battery, leakage of the electrolytic solution in the battery is suppressed.

As the polymer, a polymer used in batteries such as lithium ion secondary batteries and a general chemically cross-linked polymer are used. In particular, a polymer capable of turning into a gel by absorbing an electrolytic solution, such as polyvinylidene fluoride and polyhexafluoropropylene, and one obtained by introducing an ion conductive group to a polymer such as polyethylene oxide are suitable.

Specific examples of the polymer include polymethyl acrylate, polymethyl methacrylate, polyethylene oxide, polypropylene oxide, polyacrylonitrile, polyvinylidene fluoride, polyethylene glycol dimethacrylate, polyethylene glycol acrylate, polyglycidol, polytetrafluoroethylene, polyhexafluoropropylene, polysiloxane, polyvinyl acetate, polyvinyl alcohol, polyacrylic acid, polymethacrylic acid, polyitaconic acid, polyfumaric acid, polycrotonic acid, polyangelic acid, polycarboxylic acid such as carboxymethyl cellulose, styrene-butadiene rubbers, nitrile-butadiene rubbers, polystyrene, polycarbonate, unsaturated polyester obtained through copolymerization of maleic anhydride and glycols, polyethylene oxide derivatives having a substituent group, and a copolymer of vinylidene fluoride and hexafluoropropylene. In addition, as the polymer, a copolymer obtained through copolymerization of two or more types of monomers forming the above described specific polymers may be selected.

Polysaccharides are also suitable as the polymer. Specific examples of the polysaccharides include glycogen, cellulose, chitin, agarose, carrageenan, heparin, hyaluronic acid, pectin, amylopectin, xyloglucan, and amylose. In addition, materials containing these polysaccharides may be used as the polymer, and examples of the materials include agar containing polysaccharides such as agarose.

As the inorganic filler, inorganic ceramics such as oxides and nitrides are preferable.

Inorganic ceramics have hydrophilic and hydrophobic functional groups on their surfaces. Thus, a conductive passage may form within the inorganic ceramics when the functional groups attract the electrolytic solution. Furthermore, the inorganic ceramics dispersed in the electrolytic solution form a network among the inorganic ceramics themselves due to the functional groups, and may serve as containment of the electrolytic solution. With such a function by the inorganic ceramics, leakage of the electrolytic solution in the battery is further suitably suppressed. In order to have the inorganic ceramics suitably exert the function described above, the inorganic ceramics having a particle shape are preferable, and those whose particle sizes are nm orders are particularly preferable.

Examples of the types of the inorganic ceramics include common alumina, silica, titania, zirconia, and lithium phosphate. In addition, inorganic ceramics that have lithium conductivity themselves are preferable, and specific examples thereof include Li₃N, LiI, LiI—Li₃N—LiOH, LiI—Li₂S—P₂O₅, LiI—Li₂S—P₂S₅, LiI—Li₂S—B₂S₃, Li₂O—B₂S₃, Li₂O—V₂O₃—SiO₂, Li₂O—B₂O₃—P₂O₅, Li₂O—B₂O₃—ZnO, Li₂O—Al₂O₃—TiO₂—SiO₂—P₂O₅, LiTi₂ (PO₄)₃, Li-βAl₂O₃, and LiTaO₃.

Glass ceramics may be used as the inorganic filler. Since glass ceramics enables containment of ionic liquids, the same effect is expected for the electrolytic solution of the present invention. Examples of the glass ceramics include compounds represented by xLi₂S-(1-x) P₂S₅ (where 0<x<1), and those in which one portion of S in the compound is substituted with another element and those in which one portion of P in the compound is substituted with germanium.

Without departing from the gist of the present invention, a known additive may be added to the electrolytic solution of the present invention. Examples of such a known additive include: cyclic carbonates including an unsaturated bond represented by vinylene carbonate (VC), vinylethylene carbonate (VEC), methyl vinylene carbonate (MVC), and ethyl vinylene carbonate (EVC); carbonate compounds represented by fluoro ethylene carbonate, trifluoro propylene carbonate, phenylethylene carbonate, and erythritane carbonate; carboxylic anhydrides represented by succinic anhydride, glutaric anhydride, maleic anhydride, citraconic anhydride, glutaconic anhydride, itaconic anhydride, diglycolic anhydride, cyclohexanedicarboxylic anhydride, cyclopentanetetracarboxylic dianhydride, and phenyl succinic anhydride; lactones represented by γ-butyrolactone, γ-valerolactone, γ-caprolactone, δ-valerolactone, δ-caprolactone, and ε-caprolactone; cyclic ethers represented by 1,4-dioxane; sulfur-containing compounds represented by ethylene sulfite, 1,3-propanesultone, 1,4-butanesultone, methyl methanesulfonate, busulfan, sulfolane, sulfolene, dimethyl sulfone, and tetramethylthiuram monosulfide; nitrogen-containing compounds represented by 1-methyl-2-pyrrolidinone, 1-methyl-2-piperidone, 3-methyl-2-oxazolidinone, 1,3-dimethyl-2-imidazolidinone, and N-methylsuccinimide; phosphates represented by monofluorophosphate and difluorophosphate; saturated hydrocarbon compounds represented by heptane, octane, and cycloheptane; and unsaturated hydrocarbon compounds represented by biphenyl, alkyl biphenyl, terphenyl, partially hydrogenated terphenyl, cyclohexylbenzene, t-butylbenzene, t-amyl benzene, diphenyl ether, and dibenzofuran.

Since the electrolytic solution of the present invention described above exhibits excellent ionic conductivity, the electrolytic solution is suitably used as an electrolytic solution of a power storage device such as a battery and a capacitor. In particular, the electrolytic solution of the present invention is preferably used as electrolytic solutions of lithium ion secondary batteries. Hereinafter, a lithium ion secondary battery provided with the electrolytic solution of the present invention is sometimes referred to as a lithium ion secondary battery of the present invention.

Meanwhile, in general, a coating is known to form on the surfaces of the negative electrode and the positive electrode in a secondary battery. This coating is also known as SEI (solid electrolyte interphase), and is formed from reductive degradation products, etc. of an electrolytic solution. For example, JP2007-19027(A) describes such an SEI coating.

The SEI coating on the surfaces of the negative electrode and the positive electrode allows a charge carrier such as lithium ions to pass therethrough. In addition, the SEI coating on the surface of the negative electrode is considered to exist between the negative electrode surface and the electrolytic solution, and to suppress further reductive degradation of the electrolytic solution. The existence of the SEI coating is considered to be essential for a low potential negative electrode using a graphite- or Si-based negative electrode active material.

If continuous degradation of the electrolytic solution is suppressed due to the existence of the SEI coating, the discharge characteristics of the secondary battery after the charging and discharging cycle is considered to be improved. However, on the other hand, in a conventional secondary battery, the SEI coating on the surfaces of the negative electrode and the positive electrode has not necessarily been considered to contribute to improvement in battery characteristics.

In one mode of the electrolytic solution of the present invention, the chemical structure of the lithium salt represented by the general formula (1) includes SO₂. When a suitable electrolytic solution of the present invention is used as an electrolytic solution of a secondary battery, an S- and O-containing coating is estimated to be formed on the surface of the positive electrode and/or the negative electrode of the secondary battery as a result of partial degradation of the chemical structure represented by the general formula (1) through charging and discharging of the secondary battery. The S- and O-containing coating is estimated to have the S═O structure. Since deterioration of the electrodes and the electrolytic solution is suppressed by the electrodes being coated with the coating, durability of the secondary battery is considered to be improved.

In the electrolytic solution of the present invention, a cation and an anion derived from the lithium salt are considered to exist closer to each other when compared to a conventional electrolytic solution, and thus the anion is considered to be more likely to be reduced and degraded by being under strong electrostatic influence from the cat ion when compared to a conventional electrolytic solution. In a conventional secondary battery using a conventional electrolytic solution, the SEI coating is formed from a degradation product caused by reductive degradation of a cyclic carbonate such as ethylene carbonate contained in the electrolytic solution. However, as described above, in the electrolytic solution of the present invention in the lithium ion secondary battery of the present invention, the anion is easy to be reduced and degraded, and in addition, the lithium salt is contained at a relatively higher concentration than in a conventional electrolytic solution, and thus, the anion concentration in the electrolytic solution is high. Thus, the SEI coating in the lithium ion secondary battery of the present invention is considered to contain much degradation product derived from the anion. In addition, in the lithium ion secondary battery of the present invention, the SEI coating is formed without using a cyclic carbonate such as ethylene carbonate.

In some cases, the state of the S- and O-containing coating in a suitable lithium ion secondary battery of the present invention changes in association with charging and discharging. For example, the thickness of the S- and O-containing coating and the proportion of elements in the coating reversibly change sometimes depending on the state of charging and discharging. Thus, a portion that is derived from the degradation product of the anion as described above and is fixed in the coating, and a portion that reversibly increases and decreases associated with charging and discharging are considered to exist in the S - and O-containing coating in the lithium ion secondary battery of the present invention.

Since the S- and O-containing coating is considered to be derived from the degradation product of the electrolytic solution, a large portion or the entirety of the S- and O-containing coating is considered to be produced during and after the first charging and discharging of the secondary battery. That is, a suitable lithium ion secondary battery of the present invention has the S- and O-containing coating on the surface of the negative electrode and/or the surface of the positive electrode when being used. Components of the S- and O-containing coating are considered to be sometimes different depending on the composition of the electrode and the components contained in the electrolytic solution. In the S- and O-containing coating, the content proportion of S and O is not limited in particular. Further, components other than S and O and the amount thereof included in the S- and O-containing coating are not limited in particular. Since the S- and O-containing coating is considered to be derived from the anion of the lithium salt contained in the electrolytic solution of the present invention, components derived from the anion of the lithium salt are preferably contained in an amount greater than that of other components.

The S- and O-containing coating may be formed only on the negative electrode surface or may be formed only on the positive electrode surface. Preferably, the S- and O-containing coating is formed both on the negative electrode surface and the positive electrode surface.

A suitable lithium ion secondary battery of the present invention includes an S- and O-containing coating on the electrode, and the S- and O-containing coating is considered to have the S═O structure and contain a large amount of the cation. Furthermore, the cation contained in the S- and O-containing coating is considered to be preferentially supplied to the electrode. Thus, since the suitable lithium ion secondary battery of the present invention has an abundant source of cation near the electrode, transportation rate of the cation is considered to be also improved. As a result, the suitable lithium ion secondary battery of the present invention is considered to exhibit excellent battery characteristics because of combined effect between the electrolytic solution of the present invention and the S- and O-containing coating on the electrode.

As described above, by charging and discharging the suitable lithium ion secondary battery of the present invention, the S- and O-containing coating is estimated to be formed on the surface of the positive electrode and/or the negative electrode of the suitable lithium ion secondary battery of the present invention. The S- and O-containing coating of the suitable lithium ion secondary battery of the present invention may contain C, and may contain: a cation element such as Li; N; H; or a halogen such as F. C is estimated to be derived from an organic solvent contained in the electrolytic solution, such as a linear carbonate represented by the general formula (2).

Unlike a saturated cyclic carbonate, such as ethylene carbonate, which is generally added to the electrolytic solution and is considered to form a coating by undergoing degradation and polymerization, the coating components derived from a solvent containing C contained in the case where the solvent is a linear carbonate are estimated to be less likely to undergo polymerization due to a saturated linear structure, and to be less likely to inhibit the excellent characteristics of the coating derived from the anion of the lithium salt.

The lithium ion secondary battery of the present invention includes: a negative electrode having a negative electrode active material capable of occluding and releasing lithium ions; a positive electrode having a positive electrode active material capable of occluding and releasing lithium ions; and the electrolytic solution of the present invention.

As the negative electrode active material, a material capable of occluding and releasing lithium ions is used. Thus, the material is not limited in particular as long as the material is an elemental substance, an alloy, or a compound capable of occluding and releasing lithium ions. For example, an elemental substance from among Li, group 14 elements such as carbon, silicon, germanium, and tin, group 13 elements such as aluminum and indium, group 12 elements such as zinc and cadmium, group 15 elements such as antimony and bismuth, alkaline earth metals such as magnesium and calcium, and group 11 elements such as silver and gold may be used as the negative electrode active material. When silicon or the like is used as the negative electrode active material, a high capacity active material is obtained since a single silicon atom reacts with multiple lithium atoms. However, a problem that a significant expansion and contraction of volume is caused in association with occlusion and release of lithium may occur. Thus, in order to reduce the possibility of occurrence of the problem, an alloy or a compound obtained by combining an elemental substance of silicon or the like with another element such as a transition metal is suitably used as the negative electrode active material. Specific examples of the alloy or the compound include tin-based materials such as Ag—Sn alloys, Cu—Sn alloys, and Co—Sn alloys, carbon-based materials such as various graphites, silicon-based materials such as SiOₓ (0.3≤x≤1.6) that undergoes disproportionation into the elemental substance silicon and silicon dioxide, and a complex obtained by combining a carbon-based material with elemental substance silicon or a silicon-based material. In addition, as the negative electrode active material, an oxide such as Nb₂O₅, TiO₂, Li₄Ti₅O₁₂, WO₂, MoO₂, and Fe₂O₃, or a nitride represented by Li₃₋ₓMₓN (M=Co, Ni, Cu) may be used. With regard to the negative electrode active material, one or more types described above may be used.

A more specific example of the negative electrode active material is a graphite whose G/D ratio is not lower than 3.5. The G/D ratio is the ratio of G-band and D-band peaks in a Raman spectrum. In the Raman spectrum of graphite, G-band is observed near 1590 cm⁻¹ and D-band is observed near 1350 cm⁻¹, as peaks, respectively. G-band is derived from a graphite structure and D-band is derived from defects. Thus, having a higher G/D ratio, which is the ratio of G-band and D-band, means the graphite has higher crystallinity with fewer defects. Hereinafter, a graphite whose G/D ratio is not lower than 3.5 is sometimes referred to as a high-crystallinity graphite, and a graphite whose G/D ratio is lower than 3.5 is sometimes referred to as a low-crystallinity graphite.

As such a high-crystallinity graphite, both natural graphites and artificial graphites may be used. When a classification method based on shape is used, flake-like graphites, spheroidal graphites, block-like graphite, earthy graphites, and the like may be used. In addition, coated graphites obtained by coating the surface of a graphite with a carbon material or the like may also be used.

Examples of specific negative electrode active materials include carbon materials whose crystallite size is not larger than 20 nm, and preferably not larger than 5 nm. A larger crystallite size means that the carbon material has atoms arranged periodically and precisely in accordance with a certain rule. On the other hand, a carbon material whose crystallite size is not larger than 20 nm is considered to have atoms being in a state of poor periodicity and poor preciseness in arrangement. For example, when the carbon material is a graphite, the crystallite size becomes not larger than 20 nm when the size of a graphite crystal is not larger than 20 nm or when atoms forming the graphite are arranged irregularly due to distortion, defects, and impurities, etc.

Representative carbon materials whose crystallite size is not larger than 20 nm include hardly graphitizable carbon which is so-called hard carbon, and easily graphitizable carbon which is so-called soft carbon.

In order to measure the crystallite size of the carbon material, an X-ray diffraction method using CuKα radiation as an X-ray source may be used. With the X-ray diffraction method, the crystallite size is calculated using the following Scherrer's equation on the basis of a half width of a diffraction peak detected at a diffraction angle of 20=20 degrees to 30 degrees and the diffraction angle.

L=0.94λ/(β cos θ)

where

L: crystallite size

X: incident X-ray wavelength (1.54 angstrom)

β: half width of peak (radian)

θ: diffraction angle.

Specific examples of the negative electrode active material include materials containing silicon. A more specific example is SiOₓ (0.3≤x≤1.6) disproportionated into two phases of Si phase and silicon oxide phase. The Si phase in SiOₓ is capable of occluding and releasing lithium ions, and changes in volume associated with charging and discharging of the secondary battery. The silicon oxide phase changes less in volume associated with charging and discharging when compared to the Si phase. Thus, SiOₓ as the negative electrode active material achieves higher capacity because of the Si phase, and when included in the silicon oxide phase, suppresses change in volume of the entirety of the negative electrode active material. When “x” becomes smaller than a lower limit value, cycle characteristics of the secondary battery deteriorate since the change in volume during charging and discharging becomes too large due to the ratio of Si becoming excessive. On the other hand, if “x” becomes larger than an upper limit value, energy density is decreased due to the Si ratio being too small. The range of “x” is more preferably 0.5≤x≤1.5, and further preferably 0.7≤x≤1.2.

In SiOₓ described above, an alloying reaction between lithium and silicon in the Si phase is considered to occur during charging and discharging of the lithium ion secondary battery. This alloying reaction is considered to contribute to charging and discharging of the lithium ion secondary battery. Also in the negative electrode active material including tin described later, charging and discharging are considered to occur by an alloying reaction between tin and lithium.

Specific examples of the negative electrode active material include materials containing tin. More specific examples include Sn elemental substance, tin alloys such as Cu—Sn and Co—Sn, amorphous tin oxides, and tin silicon oxides. Examples of the amorphous tin oxides include SnB_{0.4}P_{0.6}O_{3.1}, and examples of the tin silicon oxides include SnSiO₃.

The material containing silicon and the material containing tin described above are each preferably made into a composite with a carbon material to be used as the negative electrode active material. By using those materials as a composite, the structure particularly of silicon and/or tin is stabilized, and durability of the negative electrode is improved. Making a composite mentioned above may be performed by a known method. As the carbon material used in the composite, a graphite, a hard carbon, a soft carbon, etc. may be used. The graphite may be a natural graphite or an artificial graphite.

Specific examples of the negative electrode active material include lithium titanate having a spinel structure such as Li₄₊ₓTi_{5+y}O₁₂ (−1≤x≤4, −1≤y≤1) and lithium titanate having a ramsdellite structure such as Li₂Ti₃O₇.

Specific examples of the negative electrode active material include graphites having a value of long axis/short axis of 1 to 5, and preferably 1 to 3. Here, the long axis means the length of the longest portion of a graphite particle. The short axis means the longest length in directions perpendicular to the long axis. Spheroidal graphites and meso carbon micro beads correspond to the graphite. The spheroidal graphites mean carbon materials which are artificial graphite, natural graphite, easily graphitizable carbon, and hardly graphitizable carbon, for example, and which have spheroidal or substantially spheroidal shapes.

Spheroidal graphite is obtained by grinding graphite into flakes by means of an impact grinder having a relatively small crushing force and by compressing and spheroidizing the flakes. Examples of the impact grinder include a hammer mill and a pin mill. The above operation is preferably performed with the outer-circumference line speed of the hammer or the pin of the mill set at about 50 to 200 m/s. Supply and ejection of graphite with respect to such mills are preferably performed in association with a current of air or the like.

The graphite preferably has a BET specific surface area in a range of 0.5 to 15 m²/g, and more preferably in a range of 4 to 12 m²/g. When the BET specific surface area is too large, side reaction between the graphite and the electrolytic solution is accelerated in some cases. When the BET specific surface area is too small, reaction resistance of the graphite becomes large in some cases.

The mean particle diameter of the graphite is preferably in a range of 2 to 30 μm, and more preferably in a range of 5 to 20 μm. The mean particle diameter means D50 measured by a general laser diffraction scattering type particle size distribution measuring device.

The negative electrode includes a current collector, and a negative electrode active material layer bound to the surface of the current collector.

The current collector refers to an electron conductor that is chemically inert for continuously sending a flow of current to the electrode during discharging or charging of the lithium ion secondary battery. Examples of the current collector include at least one selected from silver, copper, gold, aluminum, tungsten, cobalt, zinc, nickel, iron, platinum, tin, indium, titanium, ruthenium, tantalum, chromium, or molybdenum, and metal materials such as stainless steel. The current collector may be coated with a known protective layer. One obtained by treating the surface of the current collector with a known method may be used as the current collector.

The current collector takes forms such as a foil, a sheet, a film, a line shape, a bar shape, and a mesh. Thus, as the current collector, for example, metal foils such as copper foil, nickel foil, aluminum foil, and stainless steel foil are suitably used. When the current collector is in the form of a foil, a sheet, or a film, the thickness thereof is preferably in a range of 1 μm to 100 μm.

The negative electrode active material layer includes a negative electrode active material, and, if necessary, a binding agent and/or a conductive additive.

The binding agent serves to adhere the active material, the conductive additive, or the like, to the surface of the current collector.

As the binding agent, a known binding agent may be used such as a fluorine-containing resin such as polyvinylidene fluoride, polytetrafluoroethylene, or fluororubber, a thermoplastic resin such as polypropylene or polyethylene, an imide-based resin such as polyimide or polyamide-imide, an alkoxysilyl group-containing resin, or a styrene butadiene rubber.

In addition, a polymer having a hydrophilic group may be used as the binding agent. The lithium ion secondary battery of the present invention provided with a polymer having a hydrophilic group as the binding agent more suitably maintains the capacity thereof. Examples of the hydrophilic group of the polymer having a hydrophilic group include carboxyl group, sulfo group, silanol group, amino group, hydroxyl group, and phosphoric acid-based group such as phosphoric acid group. Among those described above, a polymer containing a carboxyl group in the molecule thereof, such as polyacrylic acid, carboxymethyl cellulose, and polymethacrylic acid, or a polymer containing a sulfo group such as poly(p-styrenesulfonic acid) is preferable.

A polymer containing a large number of carboxyl groups and/or sulfo groups, such as polyacrylic acid or a copolymer of acrylic acid and vinylsulfonic acid, is water soluble. The polymer containing the hydrophilic group is preferably a water soluble polymer, and is preferably a polymer containing multiple carboxyl groups and/or sulfo groups in a single molecule thereof in terms of the chemical structure.

A polymer containing a carboxyl group in the molecule thereof is produced through, for example, a method of polymerizing an acid monomer or a method of imparting a carboxyl group to a polymer. Examples of the acid monomer include acid monomers having one carboxyl group in respective molecules such as acrylic acid, methacrylic acid, vinylbenzoic acid, crotonic acid, pentenoic acid, angelic acid, and tiglic acid, and acid monomers having two or more carboxyl groups in respective molecules such as itaconic acid, mesaconic acid, citraconic acid, fumaric acid, maleic acid, 2-pentenedioic acid, methylenesuccinic acid, allylmalonic acid, isopropylidene succinic acid, 2,4-hexadienedioic acid, and acetylene dicarboxylic acid.

A copolymer obtained through polymerization of two or more types of acid monomers selected from the acid monomers described above may be used as the binding agent.

For example, as disclosed in JP2013-065493 (A), a polymer that includes in the molecule thereof an acid anhydride group formed through condensation of carboxyl groups of a copolymer of acrylic acid and itaconic acid is also preferably used as the binding agent. Since the binding agent has a structure derived from a monomer with high acidity by having two or more carboxyl groups in a single molecule thereof, the binding agent is considered to easily trap the lithium ions and the like before a degradation reaction of the electrolytic solution occurs during charging. Furthermore, although the polymer has an increased acidity because the polymer has more carboxyl groups per monomer when compared to polyacrylic acid and polymethacrylic acid, the acidity is not increased too much because a certain amount of carboxyl groups have changed into acid anhydride groups. Therefore, the secondary battery having the negative electrode using the polymer as the binding agent has improved initial efficiency and improved input-output characteristics.

The blending ratio of the binding agent in the negative electrode active material layer in mass ratio is preferably negative electrode active material:binding agent=1:0.005 to 1:0.3. The reason is that when too little of the binding agent is contained, moldability of the electrode deteriorates, whereas when too much of the binding agent is contained, energy density of the electrode becomes low.

The conductive additive is added for increasing conductivity of the electrode. Thus, the conductive additive is preferably added optionally when conductivity of the electrode is insufficient, and does not have to be added when conductivity of the electrode is sufficiently good. As the conductive additive, a high-conductivity electron conductor that is chemically inert may be used, and examples thereof include carbonaceous fine particle such as carbon black, graphite, vapor grown carbon fiber, and various metal particles. Examples of the carbon black include acetylene black, Ketchen black (registered trademark), furnace black, and channel black. With regard to the conductive additive described above, a single type by itself, or a combination of two or more types may be added to the active material layer. The blending ratio of the conductive additive in the negative electrode active material layer in mass ratio is preferably negative electrode active material:conductive additive=1:0.01 to 1:0.5. The reason is that when too little of the conductive additive is contained, efficient conducting paths are not formed, whereas when too much of the conductive additive is contained, moldability of the negative electrode active material layer deteriorates and energy density of the electrode becomes low.

The positive electrode used in the lithium ion secondary battery includes a positive electrode active material capable of occluding and releasing lithium ions. The positive electrode includes a current collector and a positive electrode active material layer bound to the surface of the current collector. The positive electrode active material layer includes a positive electrode active material, and, if necessary, a binding agent and/or a conductive additive. The current collector of the positive electrode is not limited in particular as long as the current collector is a metal capable of withstanding a voltage suited for the active material that is used. Examples of the current collector include at least one selected from silver, copper, gold, aluminum, tungsten, cobalt, zinc, nickel, iron, platinum, tin, indium, titanium, ruthenium, tantalum, chromium, and molybdenum, and metal materials such as stainless steel.

When the potential of the positive electrode is set to not lower than 4 V using lithium as reference, aluminum is preferably used as the current collector.

Specifically, as the positive electrode current collector, one formed from aluminum or an aluminum alloy is preferably used. Here, aluminum refers to pure aluminum, and an aluminum whose purity is not less than 99.0% is referred to as pure aluminum. An alloy obtained by adding various elements to pure aluminum is referred to as an aluminum alloy. Examples of the aluminum alloy include those that are Al—Cu based, Al—Mn based, Al—Fe based, Al—Si based, Al—Mg based, Al—Mg—Si based, and Al—Zn—Mg based.

In addition, specific examples of aluminum or the aluminum alloy include A1000 series alloys (pure aluminum based) such as JIS A1085, AlN30, etc., A3000 series alloys (Al—Mn based) such as JIS A3003, A3004, etc., and A8000 series alloys (Al—Fe based) such as JIS A8079, A8021, etc.

The current collector may be coated with a known protective layer. One obtained by treating the surface of the current collector with a known method may be used as the current collector.

The current collector takes forms such as a foil, a sheet, a film, a line shape, a bar shape, and a mesh. Thus, as the current collector, for example, metal foils such as copper foil, nickel foil, aluminum foil, and stainless steel foil are suitably used. When the current collector is in the form of a foil, a sheet, or a film, the thickness thereof is preferably in a range of 1 μm to 100 μm.

As the binding agent and the conductive additive for the positive electrode, those described with respect to the negative electrode are used at similar blending ratios.

As the positive electrode active material, a material capable of occluding and releasing lithium ions is used. Examples of the positive electrode active material include layered compounds that are LiₐNi_{b}Co_{c}Mn_{d}DₑO_{f} b+c+d+e=1; 0≤e<1; D is at least one element selected from Li, Fe, Cr, Cu, Zn, Ca, Mg, S, Si, Na, K, Al, Zr, Ti, P, Ga, Ge, V, Mo, Nb, W, or La; and 1.7≤f≤2.1) and Li₂MnO₃. Additional examples of the positive electrode active material include metal oxides having a spinel structure such as LiMn₂O₄, a solid solution formed from a mixture of a metal oxide having a spinel structure and a layered compound, and polyanion-based compounds represented by LiMPO₄, LiMVO₄, Li₂MSiO₄ (where “M” is selected from at least one of Co, Ni, Mn, or Fe), or the like. Further additional examples of the positive electrode active material include tavorite-based compounds represented by LiMPO₄F (“M” is a transition metal) such as LiFePO₄F and borate-based compounds represented by LiMBO₃ (“M” is a transition metal) such as LiFeBO₃. Any metal oxide used as the positive electrode active material may have a basic composition of the composition formulae described above, and those in which a metal element included in the basic composition is substituted with another metal element may also be used. In addition, as the positive electrode active material, one that does not contain a charge carrier (e.g., a lithium ion contributing to the charging and discharging) may also be used. For example, elemental substance sulfur (S), a compound that is a composite of sulfur and carbon, metal sulfides such as TiS₂, oxides such as V₂O₅ and MnO₂, polyaniline and anthraquinone and compounds containing such aromatics in the chemical structure, conjugate-based materials such as conjugate diacetic acid-based organic matters, and other known materials may be used. Furthermore, a compound having a stable radical such as nitroxide, nitronyl nitroxide, galvinoxyl, and phenoxyl may be used as the positive electrode active material. When a positive electrode active material not containing a charge carrier such as lithium is to be used, a charge carrier has to be added in advance to the positive electrode and/or the negative electrode using a known method. The charge carrier may be added in an ionic state, or may be added in a nonionic state such as a metal. For example, when the charge carrier is lithium, a lithium foil may be pasted to and integrated with the positive electrode and/or the negative electrode.

Specific examples of the positive electrode active material include LiNi_{0.5}Co_{0.2}Mno_{0.3}O₂, LiNi_{1/3}Co_{1/3}Mn_{1/3}O₂, LiNi_{0.5}Mno_{0.5}O₂, LiNi_{0.75}Co_{0.1}Mn_{0.15}O₂, LiMnO₂, LiNiO₂, and LiCoO₂ each having a layered rock salt structure. Another specific example of the positive electrode active material includes Li₂MnO₃—LiCoO₂.

Specific examples of the positive electrode active material include LiₓA_{y}Mn_{2-y}O₄ having a spinel structure (“A” is at least one element selected from Ca, Mg, S, Si, Na, K, Al, P, Ga, or Ge, and at least one type of metal element selected from transition metal elements, 0<x≤2.2, 0≤y≤1.). More specific examples include LiMn₂O₄, and LiNi_{0.5}Mn_{1.5}O₄.

Specific examples of the positive electrode active material include LiFePO₄, Li₂FeSiO₄, LiCoPO₄, Li₂CoPO₄, Li₂MnPO₄, Li₂MnSiO₄, and Li₂CoPO₄F.

Due to high capacity and excellent durability, the positive electrode active material is preferably a lithium composite metal oxide which contains lithium, and a transition metal including nickel, cobalt, and/or manganese. Specifically, a lithium composite metal oxide represented by a general formula of layered rock salt structure: LiₐNi_{b}Co_{c}Mn_{d}DₑO_{f} b+c+d+e=1, D is at least one element selected from W, Mo, Re, Pd, Ba, Cr, B Sb, Sr, Pb, Ga, Al, Nb, Mg, Ta, Ti, La, Zr Cu, Ca, Ir, Hf, Rh, Zr, Fe, Ge, Zn, Ru, Sc, Sn, In, Y, Bi, S, Si, Na, K, P, and V, and 1.7≤f≤3) is preferably used.

In the general formula above, the values of b, c, and d are not limited in particular as long as the values satisfy the condition above. However, the values of b, c, and d preferably satisfy 0<b<1, 0<c<1, and 0<d<1, and at least one of b, c, and d is preferably in a range of 10/100<b<90/100, 10/100<c<90/100, and 5/100<d<70/100, more preferably in a range of 20/100<b<80/100, 12/100<c<70/100, and 10/100<d<60/100, and further preferably in a range of 30/100<b<70/100, 15/100<c<50/100, and 12/100<d<50/100.

As for a, e, and f, any numerical values in the corresponding ranges specified in the general formula above may be used, and examples thereof include preferably 0.5≤a≤1.5, 0≤e<0.2, and 1.8≤f≤2.5, and more preferably 0.8≤a≤1.3, 0≤e<0.1, and 1.9≤f≤2.1, respectively.

In order to form the active material layer on the surface of the current collector, the active material may be applied on the surface of the current collector using a known conventional method such as roll coating method, die coating method, dip coating method, doctor blade method, spray coating method, and curtain coating method. Specifically, a slurry composition containing the active material, the solvent, and, if necessary, the binding agent and the conductive additive is prepared, and the prepared composition is applied on the surface of the current collector and then dried, to produce an electrode. Examples of the solvent include N-methyl-2-pyrrolidone, methanol, methyl isobutyl ketone, and water. A dispersant may be added to the slurry composition. The active material layer may be formed on one surface of the current collector, but is preferably formed on both surfaces of the current collector. In order to increase electrode density, the dried electrode is preferably compressed.

A separator is used in the lithium ion secondary battery, if necessary. The separator is for separating the positive electrode and the negative electrode to allow passage of lithium ions while preventing short circuit due to a contact of both electrodes. As the separator, one that is known may be used. Examples of the separator include porous materials, nonwoven fabrics, and woven fabrics using one or more types of materials having electrical insulation property such as: synthetic resins such as polytetrafluoroethylene, polypropylene, polyethylene, polyimide, polyamide, polyaramide (aromatic polyamide), polyester, and polyacrylonitrile; polysaccharides such as cellulose and amylose; natural polymers such as fibroin, keratin, lignin, and suberin; and ceramics. In addition, the separator may have a multilayer structure.

A specific method for producing the lithium ion secondary battery of the present invention is described.

An electrode assembly is formed from the positive electrode, the negative electrode, and, if necessary, the separator interposed therebetween. The electrode assembly may be a laminated type obtained by stacking the positive electrode, the separator, and the negative electrode, or a wound type obtained by winding the positive electrode, the separator, and the negative electrode. The lithium ion secondary battery is preferably formed by respectively connecting, using current collecting leads or the like, the positive electrode current collector to a positive electrode external connection terminal and the negative electrode current collector to a negative electrode external connection terminal, and then adding the electrolytic solution of the present invention to the electrode assembly. In addition, the lithium ion secondary battery of the present invention preferably executes charging and discharging in a voltage range suitable for the types of active materials contained in the electrodes.

The form of the lithium ion secondary battery of the present invention is not limited in particular, and various forms such as a cylindrical type, a square type, a coin type, a laminated type, etc., are used.

The lithium ion secondary battery of the present invention may be mounted on a vehicle. The vehicle may be a vehicle that uses, as all or a part of the source of power, electrical energy obtained from the lithium ion secondary battery, and examples thereof include electric vehicles and hybrid vehicles. When the lithium ion secondary battery is to be mounted on the vehicle, a plurality of the lithium ion secondary batteries may be connected in series to form an assembled battery. Other than the vehicles, examples of instruments on which the lithium ion secondary battery may be mounted include various home appliances, office instruments, and industrial instruments driven by a battery such as personal computers and portable communication devices. In addition, the lithium ion secondary battery of the present invention may be used as power storage devices and power smoothing devices for wind power generation, photovoltaic power generation, hydroelectric power generation, and other power systems, power supply sources for auxiliary machineries and/or power of ships, etc., power supply sources for auxiliary machineries and/or power of aircraft and spacecraft, etc., auxiliary power supply for vehicles that do not use electricity as a source of power, power supply for movable household robots, power supply for system backup, power supply for uninterruptible power supply devices, and power storage devices for temporarily storing power required for charging at charge stations for electric vehicles.

A capacitor of the present invention provided with the electrolytic solution of the present invention may be formed by replacing, with active carbon or the like that is used as a polarized electrode material, a part or all of the negative electrode active material or the positive electrode active material, or a part or all of the negative electrode active material and the positive electrode active material, in the lithium ion secondary battery of the present invention described above. Examples of the capacitor of the present invention include electrical double layer capacitors and hybrid capacitors such as lithium ion capacitors. As the description of the capacitor of the present invention, the description of the lithium ion secondary battery of the present invention above in which “lithium ion secondary battery” is replaced by “capacitor” as appropriate is used.

Although embodiments of the electrolytic solution of the present invention have been described above, the present invention is not limited to the embodiments. Without departing from the gist of the present invention, the present invention can be implemented in various modes with modifications and improvements, etc., that can be made by a person skilled in the art.

### EXAMPLES

In the following, the present invention is specifically described by presenting Examples and the like. The present invention is not limited to these Examples.

### Example 1-1

(FSO₂)₂NLi was dissolved in dimethyl carbonate, whereby an electrolytic solution of Example 1-1 having (FSO₂)₂NLi at a concentration of 2.04 mol/L was produced. In the electrolytic solution of Example 1-1, the organic solvent is contained at a mole ratio of 5 relative to the lithium salt.

### Example 1-2

(FSO₂)₂NLi was dissolved in dimethyl carbonate, whereby an electrolytic solution of Example 1-2 having (FSO₂)₂NLi at a concentration of 1.76 mol/L was produced. In the electrolytic solution of Example 1-2, the organic solvent is contained at a mole ratio of 5.5 relative to the lithium salt.

### Example 1-3

(FSO₂)₂NLi was dissolved in dimethyl carbonate, whereby an electrolytic solution of Example 1-3 having (FSO₂)₂NLi at a concentration of 1.65 mol/L was produced. In the electrolytic solution of Example 1-3, the organic solvent is contained at a mole ratio of 6 relative to the lithium salt.

### Example 1-4

(FSO₂)₂NLi was dissolved in dimethyl carbonate, whereby an electrolytic solution of Example 1-4 having (FSO₂)₂NLi at a concentration of 1.32 mol/L was produced. In the electrolytic solution of Example 1-4, the organic solvent is contained at a mole ratio of 8 relative to the lithium salt.

### Example 2-1

(FSO₂)₂NLi was dissolved in ethyl methyl carbonate, whereby an electrolytic solution of Example 2-1 having (FSO₂)₂NLi at a concentration of 1.68 mol/L was produced. In the electrolytic solution of Example 2-1, the organic solvent is contained at a mole ratio of 5 relative to the lithium salt.

### Example 2-2

(FSO₂)₂NLi was dissolved in ethyl methyl carbonate, whereby an electrolytic solution of Example 2-2 having (FSO₂)₂NLi at a concentration of 1.55 mol/L was produced. In the electrolytic solution of Example 2-2, the organic solvent is contained at a mole ratio of 5.5 relative to the lithium salt.

### Example 2-3

(FSO₂)₂NLi was dissolved in ethyl methyl carbonate, whereby an electrolytic solution of Example 2-3 having (FSO₂)₂NLi at a concentration of 1.43 mol/L was produced. In the electrolytic solution of Example 2-3, the organic solvent is contained at a mole ratio of 6 relative to the lithium salt.

### Example 2-4

(FSO₂)₂NLi was dissolved in ethyl methyl carbonate, whereby an electrolytic solution of Example 2-4 having (FSO₂)₂NLi at a concentration of 1.10 mol/L was produced. In the electrolytic solution of Example 2-4, the organic solvent is contained at a mole ratio of 8 relative to the lithium salt.

### Example 3-1

(FSO₂)₂NLi was dissolved in diethyl carbonate, whereby an electrolytic solution Example 3-1 having (FSO₂)₂NLi at a concentration of 1.54 mol/L was produced. In the electrolytic solution of Example 3-1, the organic solvent is contained at a mole ratio of 5 relative to the lithium salt.

### Example 3-2

(FSO₂)₂NLi was dissolved in diethyl carbonate, whereby an electrolytic solution of Example 3-2 having (FSO₂)₂NLi at a concentration of 1.43 mol/L was produced. In the electrolytic solution of Example 3-2, the organic solvent is contained at a mole ratio of 5.5 relative to the lithium salt.

### Example 3-3

(FSO₂)₂NLi was dissolved in diethyl carbonate, whereby an electrolytic solution of Example 3-3 having (FSO₂)₂NLi at a concentration of 1.34 mol/L was produced. In the electrolytic solution of Example 3-3, the organic solvent is contained at a mole ratio of 6 relative to the lithium salt.

### Example 3-4

(FSO₂)₂NLi was dissolved in diethyl carbonate, whereby an electrolytic solution of Example 3-4 having (FSO₂)₂NLi at a concentration of 1.06 mol/L was produced. In the electrolytic solution of Example 3-4, the organic solvent is contained at a mole ratio of 8 relative to the lithium salt.

### Example 4-1

(FSO₂)₂NLi was dissolved in a mixed organic solvent obtained by mixing dimethyl carbonate and ethyl methyl carbonate at a mole ratio of 99:1, whereby an electrolytic solution of Example 4-1 containing the organic solvent at a mole ratio of 5 relative to the lithium salt was produced.

### Example 4-2

(FSO₂)₂NLi was dissolved in a mixed organic solvent obtained by mixing dimethyl carbonate and ethyl methyl carbonate at a mole ratio of 99:1, whereby an electrolytic solution of Example 4-2 containing the organic solvent at a mole ratio of 5.2 relative to the lithium salt was produced.

### Example 4-3

(FSO₂)₂NLi was dissolved in a mixed organic solvent obtained by mixing dimethyl carbonate and ethyl methyl carbonate at a mole ratio of 99:1, whereby an electrolytic solution of Example 4-3 containing the organic solvent at a mole ratio of 5.5 relative to the lithium salt was produced.

### Example 5-1

(FSO₂)₂NLi was dissolved in a mixed organic solvent obtained by mixing dimethyl carbonate and ethyl methyl carbonate at a mole ratio of 9:1, whereby an electrolytic solution of Example 5-1 containing the organic solvent at a mole ratio of 5 relative to the lithium salt was produced.

### Example 5-2

(FSO₂)₂NLi was dissolved in a mixed organic solvent obtained by mixing dimethyl carbonate and ethyl methyl carbonate at a mole ratio of 9:1, whereby an electrolytic solution of Example 5-2 containing the organic solvent at a mole ratio of 5.2 relative to the lithium salt was produced.

### Example 5-3

(FSO₂)₂NLi was dissolved in a mixed organic solvent obtained by mixing dimethyl carbonate and ethyl methyl carbonate at a mole ratio of 9:1, whereby an electrolytic solution of Example 5-3 containing the organic solvent at a mole ratio of 5.5 relative to the lithium salt was produced.

### Example 6-1

(FSO₂)₂NLi was dissolved in a mixed organic solvent obtained by mixing dimethyl carbonate and ethyl methyl carbonate at a mole ratio of 8:2, whereby an electrolytic solution of Example 6-1 containing the organic solvent at a mole ratio of 5 relative to the lithium salt was produced.

### Example 6-2

(FSO₂)₂NLi was dissolved in a mixed organic solvent obtained by mixing dimethyl carbonate and ethyl methyl carbonate at a mole ratio of 8:2, whereby an electrolytic solution of Example 6-2 containing the organic solvent at a mole ratio of 5.2 relative to the lithium salt was produced.

### Example 6-3

(FSO₂)₂NLi was dissolved in a mixed organic solvent obtained by mixing dimethyl carbonate and ethyl methyl carbonate at a mole ratio of 8:2, whereby an electrolytic solution of Example 6-3 containing the organic solvent at a mole ratio of 5.5 relative to the lithium salt was produced.

### Example 7-1

(FSO₂)₂NLi was dissolved in a mixed organic solvent obtained by mixing dimethyl carbonate and ethyl methyl carbonate at a mole ratio of 7:3, whereby an electrolytic solution of Example 7-1 containing the organic solvent at a mole ratio of 5 relative to the lithium salt was produced.

### Example 7-2

(FSO₂)₂NLi was dissolved in a mixed organic solvent obtained by mixing dimethyl carbonate and ethyl methyl carbonate at a mole ratio of 7:3, whereby an electrolytic solution of Example 7-2 containing the organic solvent at a mole ratio of 5.2 relative to the lithium salt was produced.

### Example 7-3

(FSO₂)₂NLi was dissolved in a mixed organic solvent obtained by mixing dimethyl carbonate and ethyl methyl carbonate at a mole ratio of 7:3, whereby an electrolytic solution of Example 7-3 containing the organic solvent at a mole ratio of 5.5 relative to the lithium salt was produced.

### Example 8-1

(FSO₂)₂NLi was dissolved in a mixed organic solvent obtained by mixing dimethyl carbonate and ethyl methyl carbonate at a mole ratio of 6:4, whereby an electrolytic solution of Example 8-1 containing the organic solvent at a mole ratio of 5 relative to the lithium salt was produced.

### Example 8-2

(FSO₂)₂NLi was dissolved in a mixed organic solvent obtained by mixing dimethyl carbonate and ethyl methyl carbonate at a mole ratio of 6:4, whereby an electrolytic solution of Example 8-2 containing the organic solvent at a mole ratio of 5.2 relative to the lithium salt was produced.

### Example 8-3

(FSO₂)₂NLi was dissolved in a mixed organic solvent obtained by mixing dimethyl carbonate and ethyl methyl carbonate at a mole ratio of 6:4, whereby an electrolytic solution of Example 8-3 containing the organic solvent at a mole ratio of 5.5 relative to the lithium salt was produced.

### Example 9-1

(FSO₂)₂NLi was dissolved in a mixed organic solvent obtained by mixing dimethyl carbonate and ethyl methyl carbonate at a mole ratio of 5:5, whereby an electrolytic solution of Example 9-1 containing the organic solvent at a mole ratio of 5 relative to the lithium salt was produced.

### Example 9-2

(FSO₂)₂NLi was dissolved in a mixed organic solvent obtained by mixing dimethyl carbonate and ethyl methyl carbonate at a mole ratio of 5:5, whereby an electrolytic solution of Example 9-2 containing the organic solvent at a mole ratio of 5.2 relative to the lithium salt was produced.

### Example 9-3

(FSO₂)₂NLi was dissolved in a mixed organic solvent obtained by mixing dimethyl carbonate and ethyl methyl carbonate at a mole ratio of 5:5, whereby an electrolytic solution of Example 9-3 containing the organic solvent at a mole ratio of 5.5 relative to lithium salt was produced.

### Example 10-1

(FSO₂)₂NLi was dissolved in a mixed organic solvent obtained by mixing dimethyl carbonate and diethyl carbonate at a mole ratio of 8:2, whereby an electrolytic solution of Example 10-1 containing the organic solvent at a mole ratio of 5 relative to the lithium salt was produced.

### Example 10-2

(FSO₂)₂NLi was dissolved in a mixed organic solvent obtained by mixing dimethyl carbonate and diethyl carbonate at a mole ratio of 8:2, whereby an electrolytic solution of Example 10-2 containing the organic solvent at a mole ratio of 5.2 relative to the lithium salt was produced.

### Example 10-3

(FSO₂)₂NLi was dissolved in a mixed organic solvent obtained by mixing dimethyl carbonate and diethyl carbonate at a mole ratio of 8:2, whereby an electrolytic solution of Example 10-3 containing the organic solvent at a mole ratio of 5.5 relative to the lithium salt was produced.

### Example 11-1

(FSO₂)₂NLi was dissolved in a mixed organic solvent obtained by mixing dimethyl carbonate and diethyl carbonate at a mole ratio of 7:3, whereby an electrolytic solution of Example 11-1 containing the organic solvent at a mole ratio of 5 relative to the lithium salt was produced.

### Example 11-2

(FSO₂)₂NLi was dissolved in a mixed organic solvent obtained by mixing dimethyl carbonate and diethyl carbonate at a mole ratio of 7:3, whereby an electrolytic solution of Example 11-2 containing the organic solvent at a mole ratio of 5.2 relative to the lithium salt was produced.

### Example 11-3

(FSO₂)₂NLi was dissolved in a mixed organic solvent obtained by mixing dimethyl carbonate and diethyl carbonate at a mole ratio of 7:3, whereby an electrolytic solution of Example 11-3 containing the organic solvent at a mole ratio of 5.5 relative to the lithium salt was produced.

### Example 12-1

(FSO₂)₂NLi was dissolved in a mixed organic solvent obtained by mixing dimethyl carbonate and diethyl carbonate at a mole ratio of 6:4, whereby an electrolytic solution of Example 12-1 containing the organic solvent at a mole ratio of 5 relative to the lithium salt was produced.

### Example 12-2

(FSO₂)₂NLi was dissolved in a mixed organic solvent obtained by mixing dimethyl carbonate and diethyl carbonate at a mole ratio of 6:4, whereby an electrolytic solution of Example 12-2 containing the organic solvent at a mole ratio of 5.2 relative to the lithium salt was produced.

### Example 12-3

(FSO₂)₂NLi was dissolved in a mixed organic solvent obtained by mixing dimethyl carbonate and diethyl carbonate at a mole ratio of 6:4, whereby an electrolytic solution of Example 12-3 containing the organic solvent at a mole ratio of 5.5 relative to the lithium salt was produced.

### Example 13-1

LiPF₆ was dissolved in dimethyl carbonate, whereby an electrolytic solution of Example 13-1 having LiPF₆ at a concentration of 2 mol/L was produced. In the electrolytic solution of Example 13-1, the organic solvent is contained at a mole ratio of 5.31 relative to the lithium salt.

### Comparative Example 1

LiPF₆ was dissolved in a mixed solvent obtained by mixing ethylene carbonate, ethyl methyl carbonate, and dimethyl carbonate at a volume ratio of 3:3:4, whereby an electrolytic solution of Comparative Example 1 having LiPF₆ at a concentration of 1.0 mol/L was produced. In the electrolytic solution of Comparative Example 1, the organic solvent is contained at a mole ratio of about 10 relative to the lithium salt.

### Reference Example 1-1

(FSO₂)₂NLi was dissolved in dimethyl carbonate, whereby an electrolytic solution of Reference Example 1-1 having (FSO₂)₂NLi at a concentration of 3.91 mol/L was produced. In the electrolytic solution of Reference Example 1-1, the organic solvent is contained at a mole ratio of 2 relative to the lithium salt.

### Reference Example 1-2

(FSO₂)₂NLi was dissolved in dimethyl carbonate, whereby an electrolytic solution of Reference Example 1-2 having (FSO₂)₂NLi at a concentration of 3.08 mol/L was produced. In the electrolytic solution of Reference Example 1-2, the organic solvent is contained at a mole ratio of 3 relative to the lithium salt.

### Reference Example 1-3

(FSO₂)₂NLi was dissolved in dimethyl carbonate, whereby an electrolytic solution of Reference Example 1-3 having (FSO₂)₂NLi at a concentration of 2.37 mol/L was produced. In the electrolytic solution of Reference Example 1-3, the organic solvent is contained at a mole ratio of 4 relative to the lithium salt.

### Reference Example 1-4

(FSO₂)₂NLi was dissolved in dimethyl carbonate, whereby an electrolytic solution of Reference Example 1-4 having (FSO₂)₂NLi at a concentration of 1.10 mol/L was produced. In the electrolytic solution of Reference Example 1-4, the organic solvent is contained at a mole ratio of 10 relative to the lithium salt.

### Reference Example 2-1

(FSO₂)₂NLi was dissolved in ethyl methyl carbonate, whereby an electrolytic solution of Reference Example 2-1 having (FSO₂)₂NLi at a concentration of 3.41 mol/L was produced. In the electrolytic solution of Reference Example 2-1, the organic solvent is contained at a mole ratio of 2 relative to the lithium salt.

### Reference Example 2-2

(FSO₂)₂NLi was dissolved in ethyl methyl carbonate, whereby an electrolytic solution of Reference Example 2-2 having (FSO₂)₂NLi at a concentration of 2.03 mol/L was produced. In the electrolytic solution of Reference Example 2-2, the organic solvent is contained at a mole ratio of 4 relative to the lithium salt.

### Reference Example 2-3

(FSO₂)₂NLi was dissolved in ethyl methyl carbonate, whereby an electrolytic solution of Reference Example 2-3 having (FSO₂)₂NLi at a concentration of 0.90 mol/L was produced. In the electrolytic solution of Reference Example 2-3, the organic solvent is contained at a mole ratio of 10 relative to the lithium salt.

### Reference Example 3-1

(FSO₂)₂NLi was dissolved in diethyl carbonate, whereby an electrolytic solution of Reference Example 3-1 having (FSO₂)₂NLi at a concentration of 1.82 mol/L was produced. In the electrolytic solution of Reference Example 3-1, the organic solvent is contained at a mole ratio of 4 relative to the lithium salt.

### Reference Example 3-2

(FSO₂)₂NLi was dissolved in diethyl carbonate, whereby an electrolytic solution of Reference Example 3-2 having (FSO₂)₂NLi at a concentration of 0.88 mol/L was produced. In the electrolytic solution of Reference Example 3-2, the organic solvent is contained at a mole ratio of 10 relative to the lithium salt.

### Reference Example 4-1

(FSO₂)₂NLi was dissolved in a mixed organic solvent obtained by mixing dimethyl carbonate and ethyl methyl carbonate at a mole ratio of 99:1, whereby an electrolytic solution of Reference Example 4-1 containing the organic solvent at a mole ratio of 4 relative to the lithium salt was produced.

### Reference Example 4-2

(FSO₂)₂NLi was dissolved in a mixed organic solvent obtained by mixing dimethyl carbonate and ethyl methyl carbonate at a mole ratio of 99:1, whereby an electrolytic solution of Reference Example 4-2 containing the organic solvent at a mole ratio of 4.2 relative to the lithium salt was produced.

### Reference Example 4-3

(FSO₂)₂NLi was dissolved in a mixed organic solvent obtained by mixing dimethyl carbonate and ethyl methyl carbonate at a mole ratio of 99:1, whereby an electrolytic solution of Reference Example 4-3 containing the organic solvent at a mole ratio of 4.4 relative to the lithium salt was produced.

### Reference Example 4-4

(FSO₂)₂NLi was dissolved in a mixed organic solvent obtained by mixing dimethyl carbonate and ethyl methyl carbonate at a mole ratio of 99:1, whereby an electrolytic solution of Reference Example 4-4 containing the organic solvent at a mole ratio of 4.6 relative to the lithium salt was produced.

### Reference Example 4-5

(FSO₂)₂NLi was dissolved in a mixed organic solvent obtained by mixing dimethyl carbonate and ethyl methyl carbonate at a mole ratio of 99:1, whereby an electrolytic solution of Reference Example 4-5 containing the organic solvent at a mole ratio of 4.8 relative to the lithium salt was produced.

### Reference Example 5-1

(FSO₂)₂NLi was dissolved in a mixed organic solvent obtained by mixing dimethyl carbonate and ethyl methyl carbonate at a mole ratio of 9:1, whereby an electrolytic solution of Reference Example 5-1 containing the organic solvent at a mole ratio of 4 relative to the lithium salt was produced.

### Reference Example 5-2

(FSO₂)₂NLi was dissolved in a mixed organic solvent obtained by mixing dimethyl carbonate and ethyl methyl carbonate at a mole ratio of 9:1, whereby an electrolytic solution of Reference Example 5-2 containing the organic solvent at a mole ratio of 4.2 relative to the lithium salt was produced.

### Reference Example 5-3

(FSO₂)₂NLi was dissolved in a mixed organic solvent obtained by mixing dimethyl carbonate and ethyl methyl carbonate at a mole ratio of 9:1, whereby an electrolytic solution of Reference Example 5-3 containing the organic solvent at a mole ratio of 4.4 relative to the lithium salt was produced.

### Reference Example 5-4

(FSO₂)₂NLi was dissolved in a mixed organic solvent obtained by mixing dimethyl carbonate and ethyl methyl carbonate at a mole ratio of 9:1, whereby an electrolytic solution of Reference Example 5-4 containing the organic solvent at a mole ratio of 4.6 relative to the lithium salt was produced.

### Reference Example 5-5

(FSO₂)₂NLi was dissolved in a mixed organic solvent obtained by mixing dimethyl carbonate and ethyl methyl carbonate at a mole ratio of 9:1, whereby an electrolytic solution of Reference Example 5-5 containing the organic solvent at a mole ratio of 4.8 relative to the lithium salt was produced.

### Reference Example 6-1

(FSO₂)₂NLi was dissolved in a mixed organic solvent obtained by mixing dimethyl carbonate and ethyl methyl carbonate at a mole ratio of 8:2, whereby an electrolytic solution of Reference Example 6-1 containing the organic solvent at a mole ratio of 4 relative to the lithium salt was produced.

### Reference Example 6-2

(FSO₂)₂NLi was dissolved in a mixed organic solvent obtained by mixing dimethyl carbonate and ethyl methyl carbonate at a mole ratio of 8:2, whereby an electrolytic solution of Reference Example 6-2 containing the organic solvent at a mole ratio of 4.2 relative to the lithium salt was produced.

### Reference Example 6-3

(FSO₂)₂NLi was dissolved in a mixed organic solvent obtained by mixing dimethyl carbonate and ethyl methyl carbonate at a mole ratio of 8:2, whereby an electrolytic solution of Reference Example 6-3 containing the organic solvent at a mole ratio of 4.4 relative to the lithium salt was produced.

### Reference Example 6-4

(FSO₂)₂NLi was dissolved in a mixed organic solvent obtained by mixing dimethyl carbonate and ethyl methyl carbonate at a mole ratio of 8:2, whereby an electrolytic solution of Reference Example 6-4 containing the organic solvent at a mole ratio of 4.6 relative to the lithium salt was produced.

### Reference Example 6-5

(FSO₂)₂NLi was dissolved in a mixed organic solvent obtained by mixing dimethyl carbonate and ethyl methyl carbonate at a mole ratio of 8:2, whereby an electrolytic solution of Reference Example 6-5 containing the organic solvent at a mole ratio of 4.8 relative to the lithium salt was produced.

### Reference Example 7-1

(FSO₂)₂NLi was dissolved in a mixed organic solvent obtained by mixing dimethyl carbonate and ethyl methyl carbonate at a mole ratio of 7:3, whereby an electrolytic solution of Reference Example 7-1 containing the organic solvent at a mole ratio of 4 relative to the lithium salt was produced.

### Reference Example 7-2

(FSO₂)₂NLi was dissolved in a mixed organic solvent obtained by mixing dimethyl carbonate and ethyl methyl carbonate at a mole ratio of 7:3, whereby an electrolytic solution of Reference Example 7-2 containing the organic solvent at a mole ratio of 4.2 relative to the lithium salt was produced.

### Reference Example 7-3

(FSO₂)₂NLi was dissolved in a mixed organic solvent obtained by mixing dimethyl carbonate and ethyl methyl carbonate at a mole ratio of 7:3, whereby an electrolytic solution of Reference Example 7-3 containing the organic solvent at a mole ratio of 4.4 relative to the lithium salt was produced.

### Reference Example 7-4

(FSO₂)₂NLi was dissolved in a mixed organic solvent obtained by mixing dimethyl carbonate and ethyl methyl carbonate at a mole ratio of 7:3, whereby an electrolytic solution of Reference Example 7-4 containing the organic solvent at a mole ratio of 4.6 relative to the lithium salt was produced.

### Reference Example 7-5

(FSO₂)₂NLi was dissolved in a mixed organic solvent obtained by mixing dimethyl carbonate and ethyl methyl carbonate at a mole ratio of 7:3, whereby an electrolytic solution of Reference Example 7-5 containing the organic solvent at a mole ratio of 4.8 relative to the lithium salt was produced.

### Reference Example 8-1

(FSO₂)₂NLi was dissolved in a mixed organic solvent obtained by mixing dimethyl carbonate and ethyl methyl carbonate at a mole ratio of 6:4, whereby an electrolytic solution of Reference Example 8-1 containing the organic solvent at a mole ratio of 4 relative to the lithium salt was produced.

### Reference Example 8-2

(FSO₂)₂NLi was dissolved in a mixed organic solvent obtained by mixing dimethyl carbonate and ethyl methyl carbonate at a mole ratio of 6:4, whereby an electrolytic solution of Reference Example 8-2 containing the organic solvent at a mole ratio of 4.2 relative to the lithium salt was produced.

### Reference Example 8-3

(FSO₂)₂NLi was dissolved in a mixed organic solvent obtained by mixing dimethyl carbonate and ethyl methyl carbonate at a mole ratio of 6:4, whereby an electrolytic solution of Reference Example 8-3 containing the organic solvent at a mole ratio of 4.4 relative to the lithium salt was produced.

### Reference Example 8-4

(FSO₂)₂NLi was dissolved in a mixed organic solvent obtained by mixing dimethyl carbonate and ethyl methyl carbonate at a mole ratio of 6:4, whereby an electrolytic solution of Reference Example 8-4 containing the organic solvent at a mole ratio of 4.6 relative to the lithium salt was produced.

### Reference Example 8-5

(FSO₂)₂NLi was dissolved in a mixed organic solvent obtained by mixing dimethyl carbonate and ethyl methyl carbonate at a mole ratio of 6:4, whereby an electrolytic solution of Reference Example 8-5 containing the organic solvent at a mole ratio of 4.8 relative to the lithium salt was produced.

### Reference Example 9-1

(FSO₂)₂NLi was dissolved in a mixed organic solvent obtained by mixing dimethyl carbonate and ethyl methyl carbonate at a mole ratio of 5:5, whereby an electrolytic solution of Reference Example 9-1 containing the organic solvent at a mole ratio of 4 relative to the lithium salt was produced.

### Reference Example 9-2

(FSO₂)₂NLi was dissolved in a mixed organic solvent obtained by mixing dimethyl carbonate and ethyl methyl carbonate at a mole ratio of 5:5, whereby an electrolytic solution of Reference Example 9-2 containing the organic solvent at a mole ratio of 4.2 relative to the lithium salt was produced.

### Reference Example 9-3

(FSO₂)₂NLi was dissolved in a mixed organic solvent obtained by mixing dimethyl carbonate and ethyl methyl carbonate at a mole ratio of 5:5 whereby an electrolytic solution of Reference Example 9-3 containing the organic solvent at a mole ratio of 4.4 relative to the lithium salt was produced.

### Reference Example 9-4

(FSO₂)₂NLi was dissolved in a mixed organic solvent obtained by mixing dimethyl carbonate and ethyl methyl carbonate at a mole ratio of 5:5, whereby an electrolytic solution of Reference Example 9-4 containing the organic solvent at a mole ratio of 4.6 relative to the lithium salt was produced.

### Reference Example 9-5

(FSO₂)₂NLi was dissolved in a mixed organic solvent obtained by mixing dimethyl carbonate and ethyl methyl carbonate at a mole ratio of 5:5, whereby an electrolytic solution of Reference Example 9-5 containing the organic solvent at a mole ratio of 4.8 relative to the lithium salt was produced.

Table 2-1 to Table 3 show lists of electrolytic solutions of Examples and electrolytic solutions of Comparative Examples, and Table 4-1 to Table 4-7 show lists of electrolytic solutions of Reference Examples.

TABLE 2-1

| | | | | Lithium salt |
|---|---|---|---|---|
| | Lithium | Organic | | concentration |
| | salt | solvent | Y | (mol/L) |
| Example 1-1 | LiFSA | DMC | 5 | 2.04 |
| Example 1-2 | LiFSA | DMC | 5.5 | 1.76 |
| Example 1-3 | LiFSA | DMC | 6 | 1.65 |
| Example 1-4 | LiFSA | DMC | 8 | 1.32 |
| Example 2-1 | LiFSA | EMC | 5 | 1.68 |
| Example 2-2 | LiFSA | EMC | 5.5 | 1.55 |
| Example 2-3 | LiFSA | EMC | 6 | 1.43 |
| Example 2-4 | LiFSA | EMC | 8 | 1.10 |
| Example 3-1 | LiFSA | DEC | 5 | 1.54 |
| Example 3-2 | LiFSA | DEC | 5.5 | 1.43 |
| Example 3-3 | LiFSA | DEC | 6 | 1.34 |
| Example 3-4 | LiFSA | DEC | 8 | 1.06 |

The meanings of abbreviations in Table 2-1 and thereafter are as follows.

LiFSA: (FSO₂)₂NLi

DMC: dimethyl carbonate

EMC: ethyl methyl carbonate

DEC: diethyl carbonate

EC: ethylene carbonate

Y: number of moles of heteroelement-containing organic solvent/number of moles of lithium salt

TABLE 2-2

| | Lithium | | | |
|---|---|---|---|---|
| | salt | Organic solvent | X | Y |
| Example 4-1 | LiFSA | Mole ratio of | 0.01 | 5 |
| | | DMC:EMC = 99:1 | | |
| Example 4-2 | LiFSA | Mole ratio of | 0.01 | 5.2 |
| | | DMC:EMC = 99:1 | | |
| Example 4-3 | LiFSA | Mole ratio of | 0.01 | 5.5 |
| | | DMC:EMC = 99:1 | | |
| Example 5-1 | LiFSA | Mole ratio of | 0.1 | 5 |
| | | DMC:EMC = 9:1 | | |
| Example 5-2 | LiFSA | Mole ratio of | 0.1 | 5.2 |
| | | DMC:EMC = 9:1 | | |
| Example 5-3 | LiFSA | Mole ratio of | 0.1 | 5.5 |
| | | DMC:EMC = 9:1 | | |
| Example 6-1 | LiFSA | Mole ratio of | 0.2 | 5 |
| | | DMC:EMC = 8:2 | | |
| Example 6-2 | LiFSA | Mole ratio of | 0.2 | 5.2 |
| | | DMC:EMC = 8:2 | | |
| Example 6-3 | LiFSA | Mole ratio of | 0.2 | 5.5 |
| | | DMC:EMC = 8:2 | | |
| Example 7-1 | LiFSA | Mole ratio of | 0.3 | 5 |
| | | DMC:EMC = 7:3 | | |
| Example 7-2 | LiFSA | Mole ratio of | 0.3 | 5.2 |
| | | DMC:EMC = 7:3 | | |
| Example 7-3 | LiFSA | Mole ratio of | 0.3 | 5.5 |
| | | DMC:EMC = 7:3 | | |
| Example 8-1 | LiFSA | Mole ratio of | 0.4 | 5 |
| | | DMC:EMC = 6:4 | | |
| Example 8-2 | LiFSA | Mole ratio of | 0.4 | 5.2 |
| | | DMC:EMC = 6:4 | | |
| Example 8-3 | LiFSA | Mole ratio of | 0.4 | 5.5 |
| | | DMC:EMC = 6:4 | | |
| Example 9-1 | LiFSA | Mole ratio of | 0.5 | 5 |
| | | DMC:EMC = 5:5 | | |
| Example 9-2 | LiFSA | Mole ratio of | 0.5 | 5.2 |
| | | DMC:EMC = 5:5 | | |
| Example 9-3 | LiFSA | Mole ratio of | 0.5 | 5.5 |
| | | DMC:EMC = 5:5 | | |

X: number of moles of EMC/(number of moles of DMC+number of moles of EMC)

TABLE 2-3

| | Lithium | | | |
|---|---|---|---|---|
| | salt | Organic solvent | X | Y |
| Example 10-1 | LiFSA | Mole ratio of | 0.2 | 5 |
| | | DMC:DEC = 8:2 | | |
| Example 10-2 | LiFSA | Mole ratio of | 0.2 | 5.2 |
| | | DMC:DEC = 8:2 | | |
| Example 10-3 | LiFSA | Mole ratio of | 0.2 | 5.5 |
| | | DMC:DEC = 8:2 | | |
| Example 11-1 | LiFSA | Mole ratio of | 0.3 | 5 |
| | | DMC:DEC = 7:3 | | |
| Example 11-2 | LiFSA | Mole ratio of | 0.3 | 5.2 |
| | | DMC:DEC = 7:3 | | |
| Example 11-3 | LiFSA | Mole ratio of | 0.3 | 5.5 |
| | | DMC:DEC = 7:3 | | |
| Example 12-1 | LiFSA | Mole ratio of | 0.4 | 5 |
| | | DMC:DEC = 6:4 | | |
| Example 12-2 | LiFSA | Mole ratio of | 0.4 | 5.2 |
| | | DMC:DEC = 6:4 | | |
| Example 12-3 | LiFSA | Mole ratio of | 0.4 | 5.5 |
| | | DMC:DEC = 6:4 | | |

X: number of moles of DEC/(number of moles of DMC+number of moles of DEC)

TABLE 3

| | | | | Lithium salt |
|---|---|---|---|---|
| | Lithium | | | concentration |
| | salt | Organic solvent | Y | (mol/L) |
| Example13-1 | LiPF₆ | DMC | 5.31 | 2 |
| Comparative | LiPF₆ | Volume ratio of | 10 | 1.0 |
| Example 1 | | EC:EMC:DMC = 3:3:4 | | |

TABLE 4-1

| | | | | Lithium salt |
|---|---|---|---|---|
| | Lithium | Organic | | concentration |
| | salt | solvent | Y | (mol/L) |
| Reference | LiFSA | DMC | 2 | 3.91 |
| Example 1-1 | | | | |
| Reference | LiFSA | DMC | 3 | 3.08 |
| Example 1-2 | | | | |
| Reference | LiFSA | DMC | 4 | 2.37 |
| Example 1-3 | | | | |
| Reference | LiFSA | DMC | 10 | 1.10 |
| Example 1-4 | | | | |
| Reference | LiFSA | EMC | 2 | 3.41 |
| Example 2-1 | | | | |
| Reference | LiFSA | EMC | 4 | 2.03 |
| Example 2-2 | | | | |
| Reference | LiFSA | EMC | 10 | 0.90 |
| Example 2-3 | | | | |
| Reference | LiFSA | DEC | 4 | 1.82 |
| Example 3-1 | | | | |
| Reference | LiFSA | DEC | 10 | 0.88 |
| Example 3-2 | | | | |

TABLE 4-2

| | Lithium | | | |
|---|---|---|---|---|
| | salt | Organic solvent | X | Y |
| Reference | LiFSA | Mole ratio of | 0.01 | 4 |
| Example 4-1 | | DMC:EMC = 99:1 | | |
| Reference | LiFSA | Mole ratio of | 0.01 | 4.2 |
| Example 4-2 | | DMC:EMC = 99:1 | | |
| Reference | LiFSA | Mole ratio of | 0.01 | 4.4 |
| Example 4-3 | | DMC:EMC = 99:1 | | |
| Reference | LiFSA | Mole ratio of | 0.01 | 4.6 |
| Example 4-4 | | DMC:EMC = 99:1 | | |
| Reference | LiFSA | Mole ratio of | 0.01 | 4.8 |
| Example 4-5 | | DMC:EMC = 99:1 | | |

X: number of moles of EMC/(number of moles of DMC+number of moles of EMC)

TABLE 4-3

| | Lithium | | | |
|---|---|---|---|---|
| | salt | Organic solvent | X | Y |
| Reference | LiFSA | Mole ratio of | 0.1 | 4 |
| Example 5-1 | | DMC:EMC = 9:1 | | |
| Reference | LiFSA | Mole ratio of | 0.1 | 4.2 |
| Example 5-2 | | DMC:EMC = 9:1 | | |
| Reference | LiFSA | Mole ratio of | 0.1 | 4.4 |
| Example 5-3 | | DMC:EMC = 9:1 | | |
| Reference | LiFSA | Mole ratio of | 0.1 | 4.6 |
| Example 5-4 | | DMC:EMC = 9:1 | | |
| Reference | LiFSA | Mole ratio of | 0.1 | 4.8 |
| Example 5-5 | | DMC:EMC = 9:1 | | |

X: number of moles of EMC/(number of moles of DMC+number of moles of EMC)

TABLE 4-4

| | Lithium | | | |
|---|---|---|---|---|
| | salt | Organic solvent | X | Y |
| Reference | LiFSA | Mole ratio of | 0.2 | 4 |
| Example 6-1 | | DMC:EMC = 8:2 | | |
| Reference | LiFSA | Mole ratio of | 0.2 | 4.2 |
| Example 6-2 | | DMC:EMC = 8:2 | | |
| Reference | LiFSA | Mole ratio of | 0.2 | 4.4 |
| Example 6-3 | | DMC:EMC = 8:2 | | |
| Reference | LiFSA | Mole ratio of | 0.2 | 4.6 |
| Example 6-4 | | DMC:EMC = 8:2 | | |
| Reference | LiFSA | Mole ratio of | 0.2 | 4.8 |
| Example 6-5 | | DMC:EMC = 8:2 | | |

X: number of moles of EMC/(number of moles of DMC+number of moles of EMC)

TABLE 4-5

| | Lithium | | | |
|---|---|---|---|---|
| | salt | Organic solvent | X | Y |
| Reference | LiFSA | Mole ratio of | 0.3 | 4 |
| Example 7-1 | | DMC:EMC = 7:3 | | |
| Reference | LiFSA | Mole ratio of | 0.3 | 4.2 |
| Example 7-2 | | DMC:EMC = 7:3 | | |
| Reference | LiFSA | Mole ratio of | 0.3 | 4.4 |
| Example 7-3 | | DMC:EMC = 7:3 | | |
| Reference | LiFSA | Mole ratio of | 0.3 | 4.6 |
| Example 7-4 | | DMC:EMC = 7:3 | | |
| Reference | LiFSA | Mole ratio of | 0.3 | 4.8 |
| Example 7-5 | | DMC:EMC = 7:3 | | |

X: number of moles of EMC/(number of moles of DMC+number of moles of EMC)

TABLE 4-6

| | Lithium | | | |
|---|---|---|---|---|
| | salt | Organic solvent | X | Y |
| Reference | LiFSA | Mole ratio of | 0.4 | 4 |
| Example 8-1 | | DMC:EMC = 6:4 | | |
| Reference | LiFSA | Mole ratio of | 0.4 | 4.2 |
| Example 8-2 | | DMC:EMC = 6:4 | | |
| Reference | LiFSA | Mole ratio of | 0.4 | 4.4 |
| Example 8-3 | | DMC:EMC = 6:4 | | |
| Reference | LiFSA | Mole ratio of | 0.4 | 4.6 |
| Example 8-4 | | DMC:EMC = 6:4 | | |
| Reference | LiFSA | Mole ratio of | 0.4 | 4.8 |
| Example 8-5 | | DMC:EMC = 6:4 | | |

X: number of moles of EMC/(number of moles of DMC+number of moles of EMC)

TABLE 4-7

| | Lithium | | | |
|---|---|---|---|---|
| | salt | Organic solvent | X | Y |
| Reference | LiFSA | Mole ratio of | 0.5 | 4 |
| Example 9-1 | | DMC:EMC = 5:5 | | |
| Reference | LiFSA | Mole ratio of | 0.5 | 4.2 |
| Example 9-2 | | DMC:EMC = 5:5 | | |
| Reference | LiFSA | Mole ratio of | 0.5 | 4.4 |
| Example 9-3 | | DMC:EMC = 5:5 | | |
| Reference | LiFSA | Mole ratio of | 0.5 | 4.6 |
| Example 9-4 | | DMC:EMC = 5:5 | | |
| Reference | LiFSA | Mole ratio of | 0.5 | 4.8 |
| Example 9-5 | | DMC:EMC = 5:5 | | |

X: number of moles of EMC/(number of moles of DMC+number of moles of EMC)

### Evaluation Example 1: Ionic Conductivity

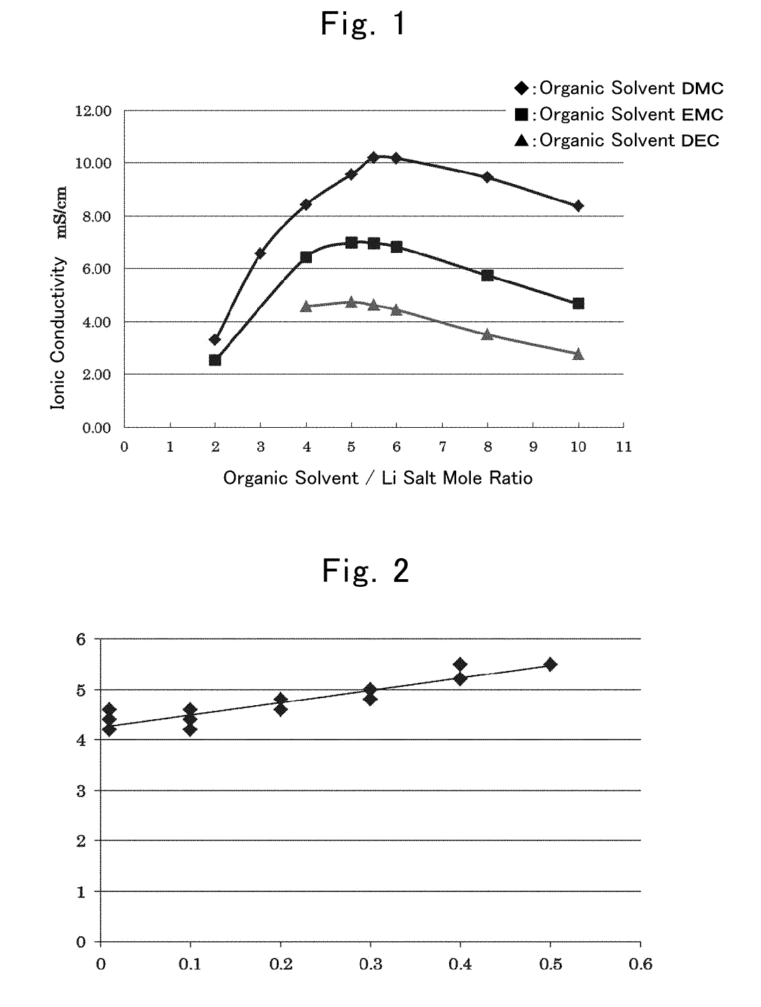

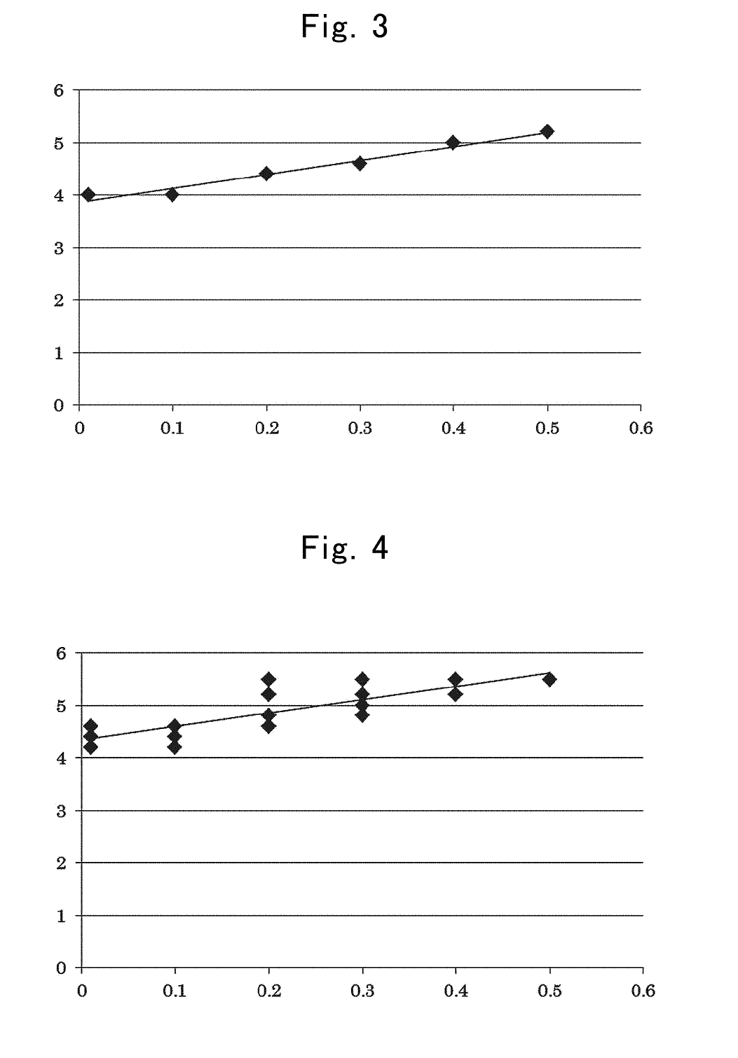

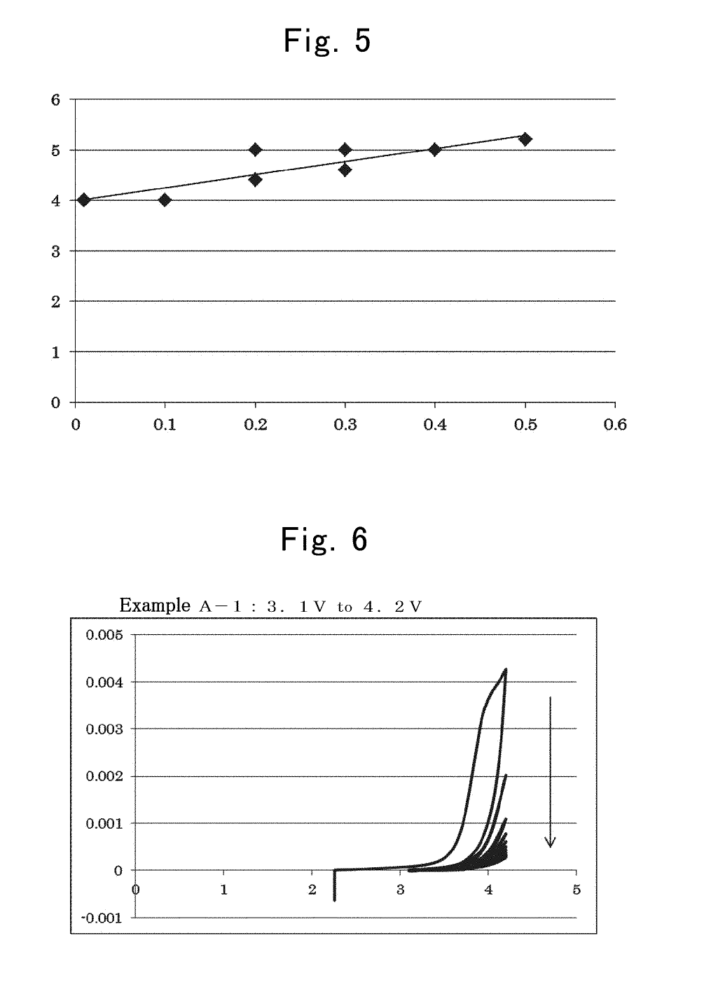

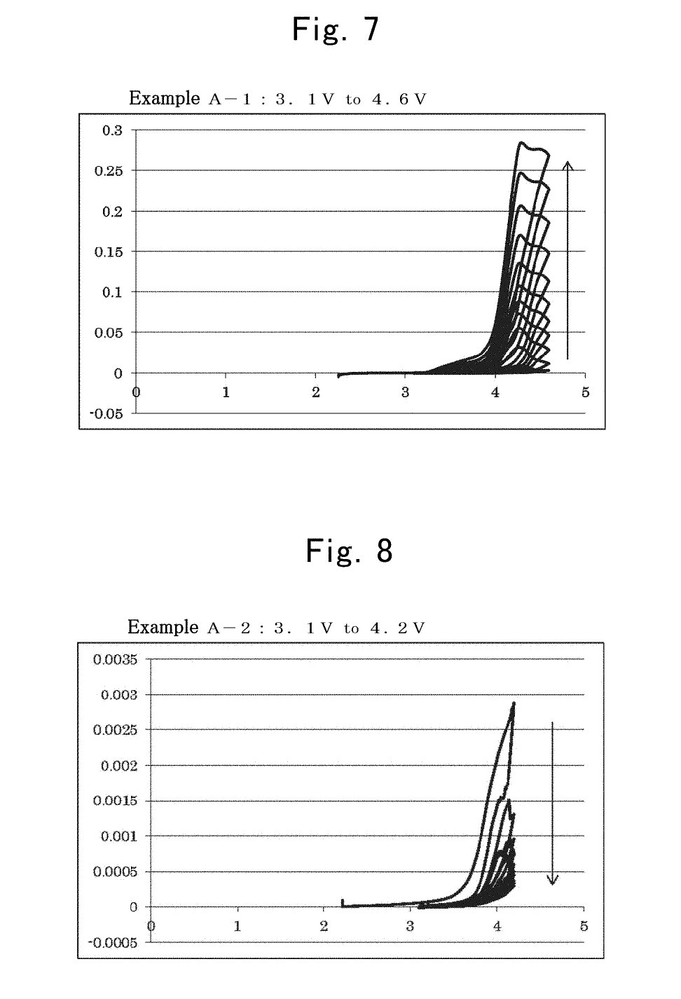

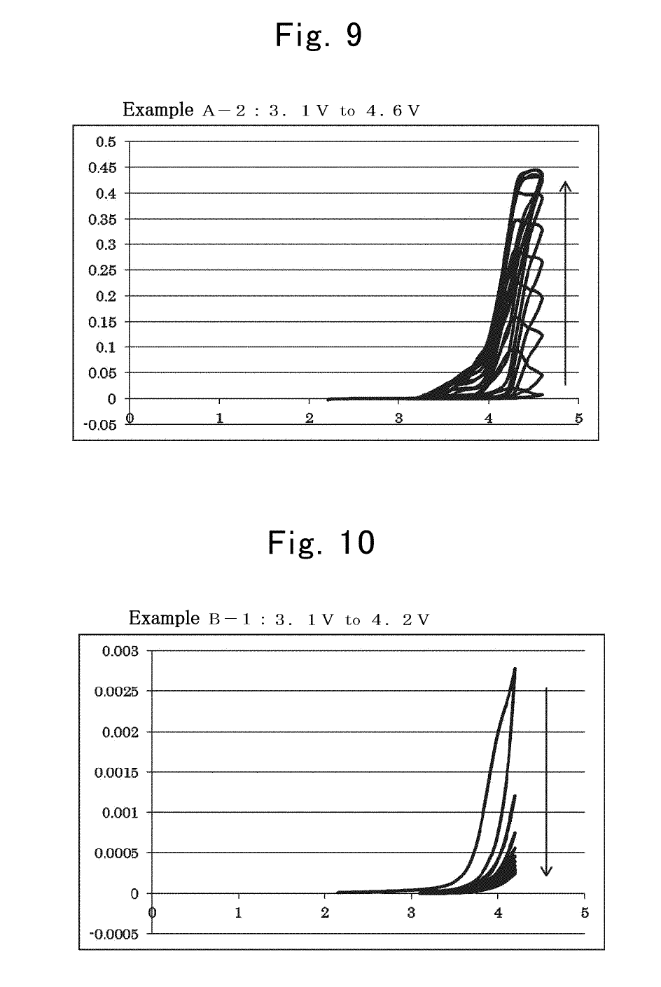

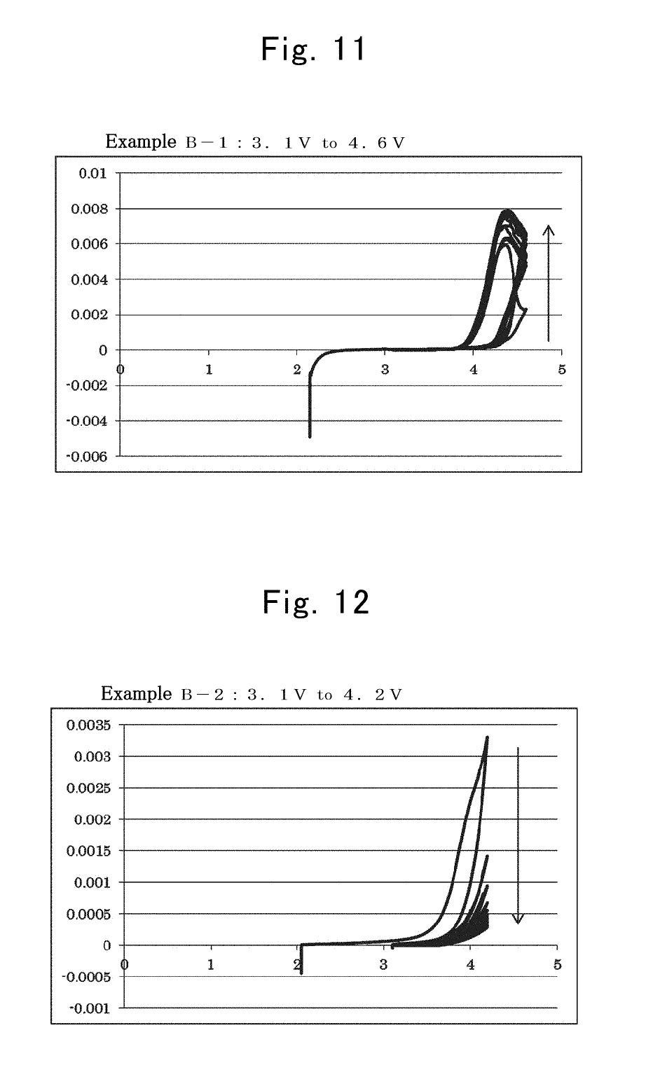

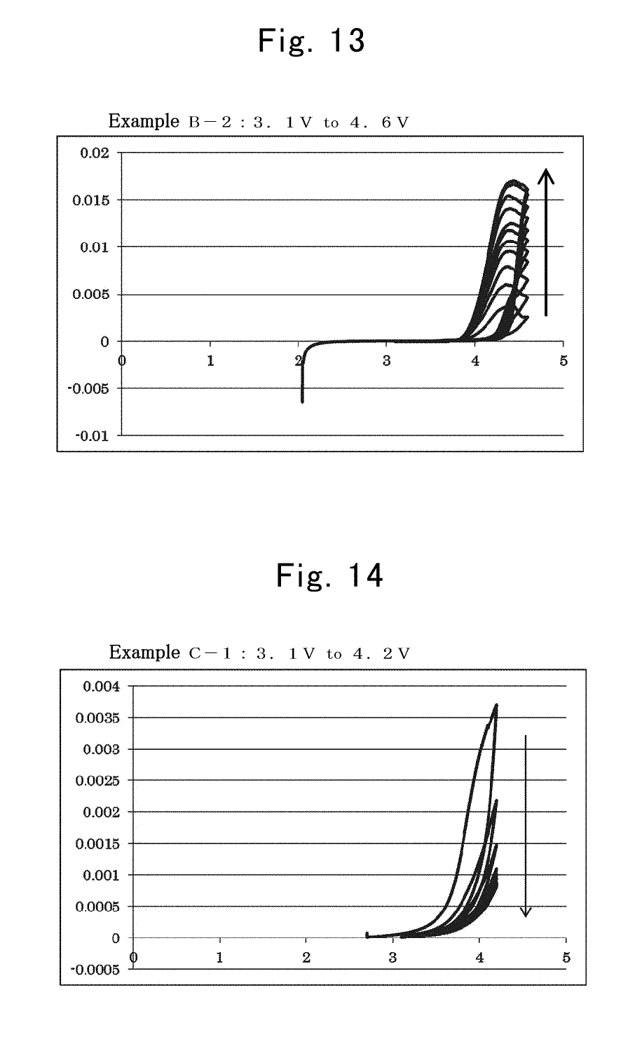

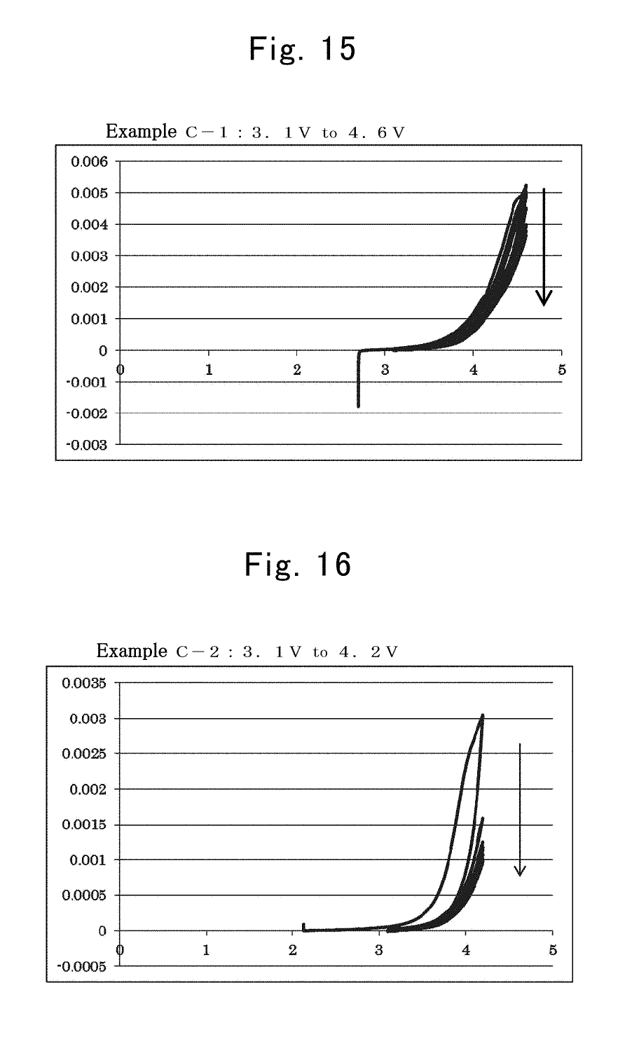

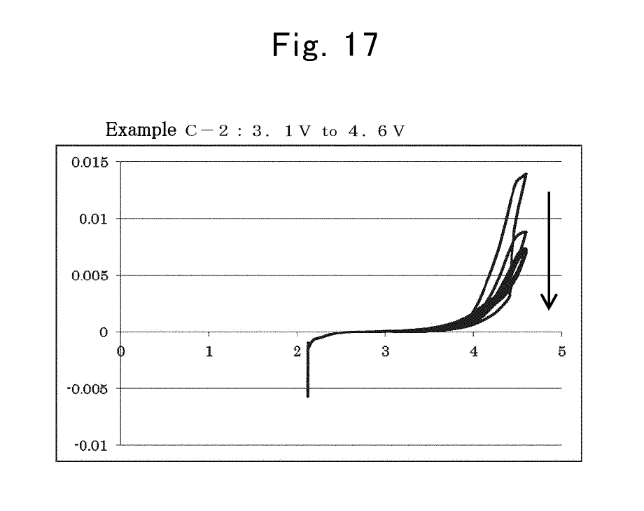

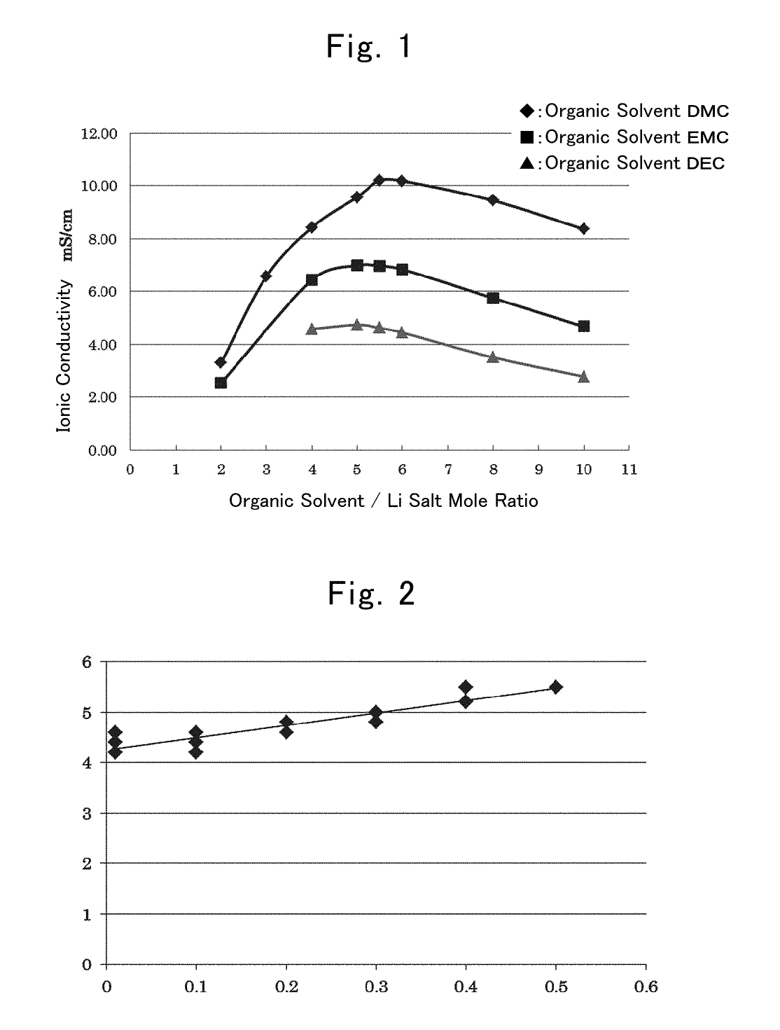

Ionic conductivities of electrolytic solutions of Examples 1-1 to 1-4 and Reference Examples 1-1 to 1-4 each having DMC as the organic solvent, electrolytic solutions of Examples 2-1 to 2-4 and Reference Examples 2-1 to 2-3 each having EMC as the organic solvent, and electrolytic solutions of Examples 3-1 to 3-4 and Reference Examples 3-1 to 3-2 each having DEC as the organic solvent were measured under the conditions shown below. The results for the respective types of the organic solvents are shown in Table 5-1, Table 5-2, Table 5-3, and FIG. 1.

Ionic Conductivity Measuring Condition

In an Ar atmosphere, an electrolytic solution was sealed in a glass cell that had a platinum electrode and whose cell constant was known, and impedance thereof was measured at 25° C., 10 kHz. Ionic conductivity was calculated from the measurement result of the impedance. As a measurement instrument, Solartron 147055BEC (Solartron Analytical) was used.

TABLE 5-1

| | | | | Ionic |
|---|---|---|---|---|
| | Lithium | Organic | | conductivity |
| | salt | solvent | Y | (mS/cm) |
| Example 1-1 | LiFSA | DMC | 5 | 9.57 |
| Example 1-2 | LiFSA | DMC | 5.5 | 10.21 |
| Example 1-3 | LiFSA | DMC | 6 | 10.18 |
| Example 1-4 | LiFSA | DMC | 8 | 9.44 |
| Reference | LiFSA | DMC | 2 | 3.31 |
| Example 1-1 | | | | |
| Reference | LiFSA | DMC | 3 | 6.58 |
| Example 1-2 | | | | |
| Reference | LiFSA | DMC | 4 | 8.43 |
| Example 1-3 | | | | |
| Reference | LiFSA | DMC | 10 | 8.36 |
| Example 1-4 | | | | |

TABLE 5-2

| | | | | Ionic |
|---|---|---|---|---|
| | Lithium | Organic | | conductivity |
| | salt | solvent | Y | (mS/cm) |
| Example 2-1 | LiFSA | EMC | 5 | 6.98 |
| Example 2-2 | LiFSA | EMC | 5.5 | 6.97 |
| Example 2-3 | LiFSA | EMC | 6 | 6.83 |
| Example 2-4 | LiFSA | EMC | 8 | 5.75 |
| Reference | LiFSA | EMC | 2 | 2.54 |
| Example 2-1 | | | | |
| Reference | LiFSA | EMC | 4 | 6.43 |
| Example 2-2 | | | | |
| Reference | LiFSA | EMC | 10 | 4.67 |
| Example 2-3 | | | | |

TABLE 5-3

| | | | | Ionic |
|---|---|---|---|---|
| | Lithium | Organic | | conductivity |
| | salt | solvent | Y | (mS/cm) |
| Example 3-1 | LiFSA | DEC | 5 | 4.74 |
| Example 3-2 | LiFSA | DEC | 5.5 | 4.63 |
| Example 3-3 | LiFSA | DEC | 6 | 4.44 |
| Example 3-4 | LiFSA | DEC | 8 | 3.51 |
| Reference | LiFSA | DEC | 4 | 4.59 |
| Example 3-1 | | | | |
| Reference | LiFSA | DEC | 10 | 2.79 |
| Example 3-2 | | | | |

From the graph shown in FIG. 1, the electrolytic solution of the present invention having was confirmed to exhibit suitable ionic conductivity. Comparison among the ionic conductivities of the electrolytic solutions having the same Y reveals that the ionic conductivity of the electrolytic solution having DMC as the organic solvent is the highest and the ionic conductivity of the electrolytic solution having EMC as the organic solvent is the second highest. In terms of ionic conductivity, among the electrolytic solutions of the present invention, the electrolytic solution having DMC as the organic solvent is considered to be preferable.

From the graph shown in FIG. 1, in any case of an electrolytic solution containing any one of the organic solvents, the ionic conductivity is estimated to indicate the maximum value when Y is in a range of 5 to 6. Further, from the result of the present Evaluation Example, also in any case of an electrolytic solution using, as the organic solvent, a mixed solvent obtained by mixing two types or three types selected from DMC, EMC, and DEC, the ionic conductivity is estimated to indicate the maximum value when Y is in a range of 5 to 6. The electrolytic solution of the present invention having was confirmed to exhibit more suitable ionic conductivity.

### Evaluation Example 2: DSC Measurement 1

The electrolytic solution of Example 4-1 was placed in a pan made from aluminum, and the pan was sealed. Using an empty sealed pan as a control, differential scanning calorimetry analysis was performed in a nitrogen atmosphere using the temperature program below. As a differential scanning calorimeter, DSC Q2000 (manufactured by TA Instruments) was used.

Temperature Program

Decrease the temperature from room temperature to −75° C. at 5° C./min., and keep the temperature for 10 minutes→increase the temperature to 70° C. at 5° C./min.

The DSC curve during the temperature decrease and during the temperature increase was observed. Also with respect to the electrolytic solutions of Example 4-2 to Example 12-3, and the electrolytic solutions of Reference Example 4-1 to Reference Example 9-5, differential scanning calorimetry analysis was performed in a similar manner (however, measurement on the electrolytic solution of Reference Example 7-2 was not performed). The results are shown in Table 6-1 to Table 6-8. The peak during the temperature decrease was observed as an exothermic peak. This peak means that the electrolytic solution solidified. The peak during the temperature increase was observed as an exothermic peak and an endothermic peak, or as an endothermic peak. The exothermic peak during the temperature increase means that the electrolytic solution having been in a supercooled state solidified, and the endothermic peak during the temperature increase means that the solidified electrolytic solution melted.

TABLE 6-1

| | | | Peak | |
|---|---|---|---|---|
| | | | observed | Peak observed |
| | | | during | during |
| | | | temperature | temperature |
| | X | Y | decrease | increase |
| Example 4-1 | 0.01 | 5 | exothermic | exothermic |
| | | | peak | peak and |
| | | | | endothermic |
| | | | | peak |
| Example 4-2 | 0.01 | 5.2 | exothermic | exothermic |
| | | | peak | peak and |
| | | | | endothermic |
| | | | | peak |
| Example 4-3 | 0.01 | 5.5 | exothermic | exothermic |
| | | | peak | peak and |
| | | | | endothermic |
| | | | | peak |
| Example 5-1 | 0.1 | 5 | exothermic | endothermic |
| | | | peak | peak |
| Example 5-2 | 0.1 | 5.2 | exothermic | endothermic |
| | | | peak | peak |
| Example 5-3 | 0.1 | 5.5 | exothermic | endothermic |
| | | | peak | peak |
| Example 6-1 | 0.2 | 5 | exothermic | endothermic |
| | | | peak | peak |
| Example 6-2 | 0.2 | 5.2 | exothermic | endothermic |
| | | | peak | peak |
| Example 6-3 | 0.2 | 5.5 | exothermic | endothermic |
| | | | peak | peak |
| Example 7-1 | 0.3 | 5 | none | exothermic |
| | | | | peak and |
| | | | | endothermic |
| | | | | peak |
| Example 7-2 | 0.3 | 5.2 | exothermic | endothermic |
| | | | peak | peak |
| Example 7-3 | 0.3 | 5.5 | exothermic | endothermic |
| | | | peak | peak |
| Example 8-1 | 0.4 | 5 | none | none |
| Example 8-2 | 0.4 | 5.2 | none | exothermic |
| | | | | peak and |
| | | | | endothermic |
| | | | | peak |
| Example 8-3 | 0.4 | 5.5 | none | exothermic |
| | | | | peak and |
| | | | | endothermic |
| | | | | peak |
| Example 9-1 | 0.5 | 5 | none | none |
| Example 9-2 | 0.5 | 5.2 | none | none |
| Example 9-3 | 0.5 | 5.5 | none | exothermic |
| | | | | peak and |
| | | | | endothermic |
| | | | | peak |

TABLE 6-2

| | | | Peak | Peak |
|---|---|---|---|---|
| | | | observed | observed |
| | | | during | during |
| | | | temperature | temperature |
| | X | Y | decrease | increase |
| Example 10-1 | 0.2 | 5 | none | none |
| Example 10-2 | 0.2 | 5.2 | none | exothermic |
| | | | | peak and |
| | | | | endothermic |
| | | | | peak |
| Example 10-3 | 0.2 | 5.5 | none | exothermic |
| | | | | peak and |
| | | | | endothermic |
| | | | | peak |
| Example 11-1 | 0.3 | 5 | none | none |
| Example 11-2 | 0.3 | 5.2 | none | exothermic |
| | | | | peak and |
| | | | | endothermic |
| | | | | peak |
| Example 11-3 | 0.3 | 5.5 | none | exothermic |
| | | | | peak and |
| | | | | endothermic |
| | | | | peak |
| Example 12-1 | 0.4 | 5 | none | none |
| Example 12-2 | 0.4 | 5.2 | none | none |
| Example 12-3 | 0.4 | 5.5 | none | none |

TABLE 6-3

| | | | | Peak |
|---|---|---|---|---|
| | | | Peak observed | observed |
| | | | during | during |
| | | | temperature | temperature |
| | X | Y | decrease | increase |
| Reference | 0.01 | 4 | none | none |
| Example 4-1 | | | | |
| Reference | 0.01 | 4.2 | none | exothermic |
| Example 4-2 | | | | peak and |
| | | | | endothermic |
| | | | | peak |
| Reference | 0.01 | 4.4 | none | exothermic |
| Example 4-3 | | | | peak and |
| | | | | endothermic |
| | | | | peak |
| Reference | 0.01 | 4.6 | none | exothermic |
| Example 4-4 | | | | peak and |
| | | | | endothermic |
| | | | | peak |
| Reference | 0.01 | 4.8 | exothermic | exothermic |
| Example 4-5 | | | peak | peak and |
| | | | | endothermic |
| | | | | peak |

TABLE 6-4

| | | | Peak | Peak |
|---|---|---|---|---|
| | | | observed | observed |
| | | | during | during |
| | | | temperature | temperature |
| | X | Y | decrease | increase |
| Reference | 0.1 | 4 | none | none |
| Example 5-1 | | | | |
| Reference | 0.1 | 4.2 | none | exothermic |
| Example 5-2 | | | | peak and |
| | | | | endothermic |
| | | | | peak |
| Reference | 0.1 | 4.4 | none | exothermic |
| Example 5-3 | | | | peak and |
| | | | | endothermic |
| | | | | peak |
| Reference | 0.1 | 4.6 | none | exothermic |
| Example 5-4 | | | | peak and |
| | | | | endothermic |
| | | | | peak |
| Reference | 0.1 | 4.8 | exothermic | exothermic |
| Example 5-5 | | | peak | peak and |
| | | | | endothermic |
| | | | | peak |

TABLE 6-5

| | | | Peak | Peak |
|---|---|---|---|---|
| | | | observed | observed |
| | | | during | during |
| | | | temperature | temperature |
| | X | Y | decrease | increase |
| Reference | 0.2 | 4 | none | none |
| Example 6-1 | | | | |
| Reference | 0.2 | 4.2 | none | none |
| Example 6-2 | | | | |
| Reference | 0.2 | 4.4 | none | none |
| Example 6-3 | | | | |
| Reference | 0.2 | 4.6 | none | exothermic |
| Example 6-4 | | | | peak and |
| | | | | endothermic |
| | | | | peak |
| Reference | 0.2 | 4.8 | none | exothermic |
| Example 6-5 | | | | peak and |
| | | | | endothermic |
| | | | | peak |

TABLE 6-6

| | | | Peak | Peak |
|---|---|---|---|---|
| | | | observed | observed |
| | | | during | during |
| | | | temperature | temperature |
| | X | Y | decrease | increase |
| Reference | 0.3 | 4 | none | none |
| Example 7-1 | | | | |
| Reference | 0.3 | 4.2 | | |
| Example 7-2 | | | | |
| Reference | 0.3 | 4.4 | none | none |
| Example 7-3 | | | | |
| Reference | 0.3 | 4.6 | none | none |
| Example 7-4 | | | | |
| Reference | 0.3 | 4.8 | none | exothermic |
| Example 7-5 | | | | peak and |
| | | | | endothermic |
| | | | | peak |

TABLE 6-7

| | | | | Peak |
|---|---|---|---|---|
| | | | Peak observed | observed |
| | | | during | during |
| | | | temperature | temperature |
| | X | Y | decrease | increase |
| Reference | 0.4 | 4 | none | none |
| Example 8-1 | | | | |
| Reference | 0.4 | 4.2 | none | none |
| Example 8-2 | | | | |
| Reference | 0.4 | 4.4 | none | none |
| Example 8-3 | | | | |
| Reference | 0.4 | 4.6 | none | none |
| Example 8-4 | | | | |
| Reference | 0.4 | 4.8 | none | none |
| Example 8-5 | | | | |

TABLE 6-8

| | | | Peak | Peak |
|---|---|---|---|---|
| | | | observed | observed |
| | | | during | during |
| | | | temperature | temperature |
| | X | Y | decrease | increase |
| Reference | 0.5 | 4 | none | none |
| Example 9-1 | | | | |
| Reference | 0.5 | 4.2 | none | none |
| Example 9-2 | | | | |
| Reference | 0.5 | 4.4 | none | none |
| Example 9-3 | | | | |
| Reference | 0.5 | 4.6 | none | none |
| Example 9-4 | | | | |
| Reference | 0.5 | 4.8 | none | none |
| Example 9-5 | | | | |

With respect to the electrolytic solutions using DMC and EMC as the organic solvent (the electrolytic solutions of Example 4-1 to Example 9-3, and the electrolytic solutions of Reference Example 4-1 to Reference Example 9-5), Table 6-9 indicates ∘ for the electrolytic solutions for which no peak was observed during the temperature decrease and during the temperature increase, A for the electrolytic solutions for which no peak was observed during the temperature decrease but the peak was observed during the temperature increase, and □ for the electrolytic solutions for which the peak was observed during the temperature decrease and during the temperature increase.

TABLE 6-9

X

| | | 0.01 | 0.1 | 0.2 | 0.3 | 0.4 | 0.5 |
|---|---|---|---|---|---|---|---|
| Y | 5.5 | □ | □ | □ | □ | Δ | Δ |
| | 5.2 | □ | □ | □ | □ | Δ | ∘ |
| | 5 | □ | □ | □ | Δ | ∘ | ∘ |
| | 4.8 | □ | □ | Δ | Δ | ∘ | ∘ |
| | 4.6 | Δ | Δ | Δ | ∘ | ∘ | ∘ |
| | 4.4 | Δ | Δ | ∘ | ∘ | ∘ | ∘ |
| | 4.2 | Δ | Δ | ∘ | | ∘ | ∘ |
| | 4 | ∘ | ∘ | ∘ | ∘ | ∘ | ∘ |

Table 6-9 reveals that the smaller the Y is, the more the solidification of the electrolytic solution at low temperature is suppressed. In addition, Table 6-9 reveals that the larger the X is, the more the solidification of the electrolytic solution at low temperature is suppressed.

All combinations of X and Y of the electrolytic solutions indicated with Δ in Table 6-9 are listed in Table 6-10 and Table 6-11. Regression analysis was performed on X and Y in Table 6-10 and Table 6-11, and a relational expression between X and Y was calculated using least-squares method. This relational expression indicates the border with respect to which the electrolytic solution solidifies or not in a low temperature condition of about −70° C. The relational expression between X and Y was Y=2.4X+4.3, and the correlation coefficient r between X and Y was 0.92. Strong correlation between X and Y was statistically confirmed. A graph obtained by plotting data of Table 6-10 and Table 6-11 is shown in FIG. 2.

TABLE 6-10

X

| | 0.01 | 0.01 | 0.01 | 0.1 | 0.1 | 0.1 | 0.2 | 0.2 |
|---|---|---|---|---|---|---|---|---|
| Y | 4.2 | 4.4 | 4.6 | 4.2 | 4.4 | 4.6 | 4.6 | 4.8 |

TABLE 6-11

| | X | | | | |
|---|---|---|---|---|---|
| | 0.3 | 0.3 | 0.4 | 0.4 | 0.5 |
| Y | 4.8 | 5 | 5.2 | 5.5 | 5.5 |

With respect to the electrolytic solutions indicated with Δ in Table 6-9, combinations of each X and the smallest Y for the X are listed in Table 6-12. Regression analysis was performed on X and Y in Table 6-12, and a relational expression between X and Y was calculated using least-squares method. This relational expression indicates the border line on the side where solidification is less likely to occur, in the border with respect to which the electrolytic solution solidifies or not in a low temperature condition of about −70° C. The relational expression between X and Y was Y=2.8X+4.0, and the correlation coefficient r between X and Y was 0.98. Also with this technique, strong correlation between X and Y was statistically confirmed.

TABLE 6-12

X

| | 0.01 | 0.1 | 0.2 | 0.3 | 0.4 | 0.5 |
|---|---|---|---|---|---|---|
| Y | 4.2 | 4.2 | 4.6 | 4.8 | 5.2 | 5.5 |

With respect to the electrolytic solutions indicated with A in Table 6-9, combinations of each X and the largest Y for the X are listed in Table 6-13. Regression analysis was performed on X and Y in Table 6-13, and a relational expression between X and Y was calculated using least-squares method. This relational expression indicates the border line on the side where solidification is easy to occur, in the border with respect to which the electrolytic solution solidifies or not in a low temperature condition of about −70° C. The relational expression between X and Y was Y=2.2X+4.5, and the correlation coefficient r between X and Y was 0.96. Also with this technique, strong correlation between X and Y was statistically confirmed.

TABLE 6-13

X

| | 0.01 | 0.1 | 0.2 | 0.3 | 0.4 | 0.5 |
|---|---|---|---|---|---|---|
| Y | 4.6 | 4.6 | 4.8 | 5 | 5.5 | 5.5 |

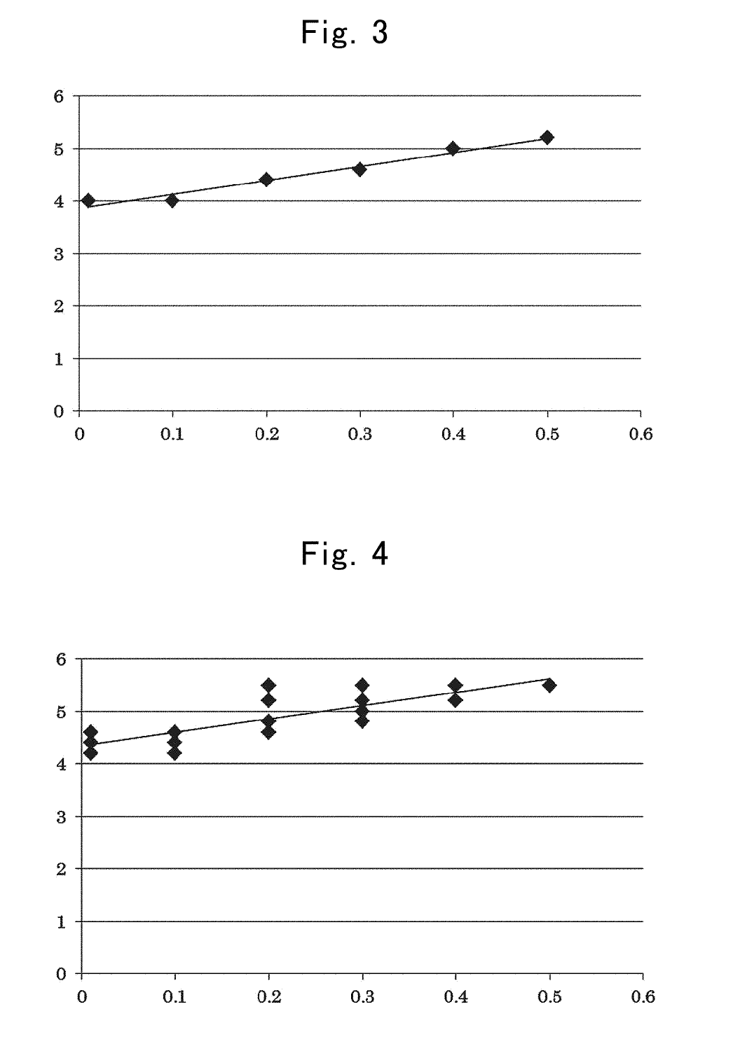

With respect to the electrolytic solutions indicated with ∘ in Table 6-9, combinations of each X and the largest Y for the X are listed in Table 6-14. Regression analysis was performed on X and Y in Table 6-14, and a relational expression between X and Y was calculated using least-squares method. This relational expression indicates where the electrolytic solution did not solidify in a low temperature condition of about −70° C. The relational expression between X and Y was Y=2.7X+3.9, and the correlation coefficient r between X and Y was 0.98. Strong correlation between X and Y was statistically confirmed. A graph obtained by plotting data of Table 6-14 is shown in FIG. 3.

TABLE 6-14

X

| | 0.01 | 0.1 | 0.2 | 0.3 | 0.4 | 0.5 |
|---|---|---|---|---|---|---|
| Y | 4 | 4 | 4.4 | 4.6 | 5 | 5.2 |

With respect to the electrolytic solutions using DMC and DEC as the organic solvent (Example 10-1 to Example 12-3), Table 6-15 indicates ∘ for the electrolytic solutions for which no peak was observed during the temperature decrease and during the temperature increase, Δ for the electrolytic solutions for which no peak was observed during the temperature decrease but the peak was observed during the temperature increase, and D for the electrolytic solutions for which the peak was observed during the temperature decrease and during the temperature increase.

TABLE 6-15

| | | X | | |
|---|---|---|---|---|
| | | 0.2 | 0.3 | 0.4 |
| Y | 5.5 | Δ | Δ | ◯ |
| | 5.2 | Δ | Δ | ◯ |
| | 5 | ◯ | ◯ | ◯ |

Table 6-15 reveals that the smaller the Y is, the more the solidification of the electrolytic solution at low temperature is suppressed. In addition, Table 6-15 reveals that the larger the X is, the more the solidification of the electrolytic solution at low temperature is suppressed.

All combinations of X and Y of the electrolytic solutions indicated with A in Table 6-9 and Table 6-15 are listed in Table 6-16 and Table 6-17. Regression analysis was performed on X and Y in Table 6-16 and Table 6-17, and a relational expression between X and Y was calculated using least-squares method. This relational expression indicates the border with respect to which groups of electrolytic solutions having different types of solvents solidify or not in a low temperature condition of about −70° C. The relational expression between X and Y was Y=2.6X+4.3, and the correlation coefficient r between X and Y was 0.81. Even with respect to the groups of electrolytic solutions having different types of solvents, strong correlation between X and Y was statistically confirmed. A graph obtained by plotting data in Table 6-16 and Table 6-17 is shown in FIG. 4.

TABLE 6-16

| | X | | | | | | | | |
|---|---|---|---|---|---|---|---|---|---|
| | 0.01 | 0.01 | 0.01 | 0.1 | 0.1 | 0.1 | 0.2 | 0.2 | 0.2 |
| Y | 4.2 | 4.4 | 4.6 | 4.2 | 4.4 | 4.6 | 4.6 | 4.8 | 5.2 |

TABLE 6-17

X

| | 0.2 | 0.3 | 0.3 | 0.3 | 0.3 | 0.4 | 0.4 | 0.5 |
|---|---|---|---|---|---|---|---|---|
| Y | 5.5 | 4.8 | 5 | 5.2 | 5.5 | 5.2 | 5.5 | 5.5 |

With respect to the electrolytic solutions indicated with Δ in Table 6-9 and Table 6-15, combinations of each X and the smallest Y for the X in each table are listed in Table 6-18. Regression analysis was performed on X and Y in Table 6-18, and a relational expression between X and Y was calculated using least-squares method. This relational expression indicates the border line on the side where solidification is less likely to occur, in the border with respect to which the groups of electrolytic solutions having different types of solvents solidify or not in a low temperature condition of about −70° C. The relational expression between X and Y was Y=2.7X+4.2, and the correlation coefficient r between X and Y was 0.88. Also with this technique, strong correlation between X and Y was statistically confirmed.

TABLE 6-18

X

| | 0.01 | 0.1 | 0.2 | 0.2 | 0.3 | 0.3 | 0.4 | 0.5 |
|---|---|---|---|---|---|---|---|---|
| Y | 4.2 | 4.2 | 4.6 | 5.2 | 4.8 | 5.2 | 5.2 | 5.5 |

With respect to the electrolytic solutions indicated with A in Table 6-9 and Table 6-15, combinations of each X and the largest Y for the X in each table are listed in Table 6-19. Regression analysis was performed on X and Y in Table 6-19, and a relational expression between X and Y was calculated using least-squares method. This relational expression indicates the border line on the side where solidification is easy to occur, in the border with respect to which the groups of electrolytic solutions having different types of solvents solidify or not in a low temperature condition of about −70° C. The relational expression between X and Y was Y=2.1X+4.6, and the correlation coefficient r between X and Y was 0.78. Also with this technique, strong correlation between X and Y was statistically confirmed.

TABLE 6-19

X

| | 0.01 | 0.1 | 0.2 | 0.2 | 0.3 | 0.3 | 0.4 | 0.5 |
|---|---|---|---|---|---|---|---|---|
| Y | 4.6 | 4.6 | 4.8 | 5.5 | 5 | 5.5 | 5.5 | 5.5 |

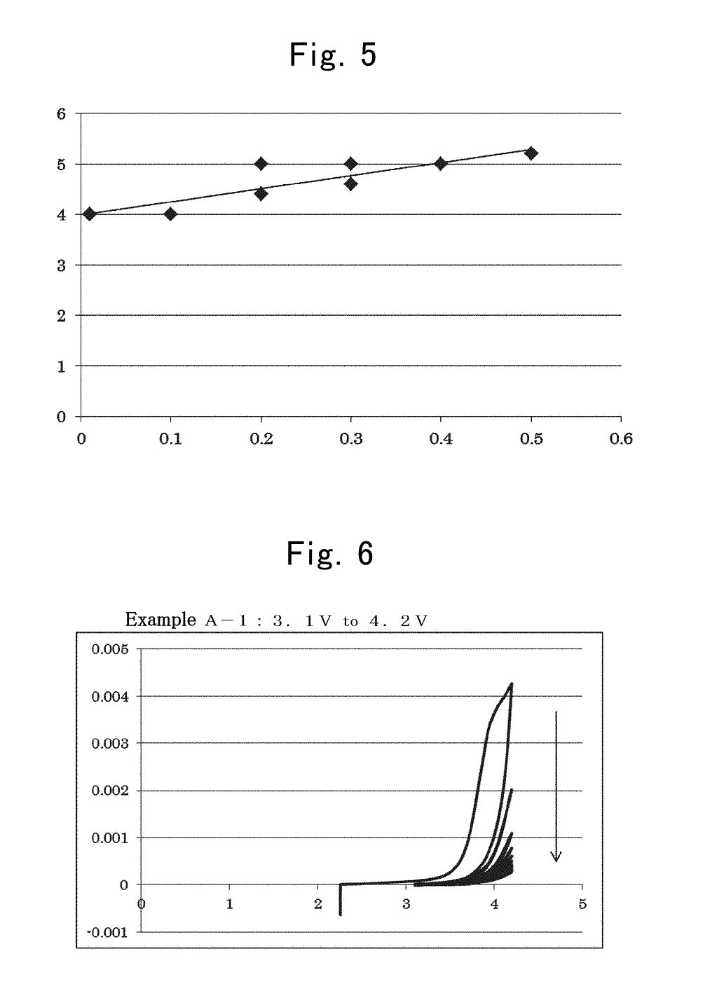

Further, with respect to the electrolytic solutions indicated with ∘ in Table 6-9 and Table 6-15, combinations of each X and the largest Y for the X in each table are listed in Table 6-20. Regression analysis was performed on X and Y in Table 6-20, and a relational expression between X and Y was calculated using least-squares method. This relational expression indicates where the groups of electrolytic solutions having different types of solvents did not solidify in a low temperature condition of about −70° C. The relational expression between X and Y was Y=2.6X+4.0, and the correlation coefficient r between X and Y was 0.86. Strong correlation between X and Y was statistically confirmed. A graph obtained by plotting data in Table 6-20 is shown in FIG. 5 together with the relational expression between X and Y.

TABLE 6-20

X

| | 0.01 | 0.1 | 0.2 | 0.2 | 0.3 | 0.3 | 0.4 | 0.5 |
|---|---|---|---|---|---|---|---|---|
| Y | 4 | 4 | 4.4 | 5 | 4.6 | 5 | 5 | 5.2 |

The combination of X=0.4 and Y=5.5 in Table 6-15 is not included in Table 6-20. If the combination is included and a relational expression of X and Y is calculated in a manner similar to that above, the relational expression X and Y is Y=2.9X+4.0, and the correlation coefficient r between X and Y is 0.86.

The relational expression between X and Y calculated from the statistical processing described above, the condition (inequality) for a suitable electrolytic solution of the present invention derived from the relational expression, and the relationship between the slope a and the intercept b calculated from each relational expression are shown in Table 6-21 below. In general, the range of mean value±standard deviation×3 is a range in which data exists at a probability of 99.7%.

TABLE 6-21

| | Condition for suitable | | |
|---|---|---|---|
| Relational | electrolytic solution | | |
| expression | of the present | | |
| between X and Y | invention | Slope a | Intercept b |
| Y = 2.4X + 4.3 | Y ≤ 2.4X + 4.3 | 2.4 | 4.3 |
| Y = 2.8X + 4.0 | Y ≤ 2.8X + 4.0 | 2.8 | 4.0 |
| Y = 2.2X + 4.5 | Y ≤ 2.2X + 4.5 | 2.2 | 4.5 |
| Y = 2.7X + 3.9 | Y ≤ 2.7X + 3.9 | 2.7 | 3.9 |
| Y = 2.6X + 4.3 | Y ≤ 2.6X + 4.3 | 2.6 | 4.3 |
| Y = 2.7X + 4.2 | Y ≤ 2.7X + 4.2 | 2.7 | 4.2 |
| Y = 2.1X + 4.6 | Y ≤ 2.1X + 4.6 | 2.1 | 4.6 |
| Y = 2.6X + 4.0 | Y ≤ 2.6X + 4.0 | 2.6 | 4.0 |
| Y = 2.9X + 4.0 | Y ≤ 2.9X + 4.0 | 2.9 | 4.0 |
| | maximum value | 2.9 | 4.6 |
| | minimum value | 2.1 | 3.9 |
| | mean value | 2.6 | 4.2 |
| | standard deviation | 0.27 | 0.24 |
| | mean value ± standard | 2.6 ± 0.8 | 4.2 ± 0.7 |
| | deviation × 3 | | |

From the value of mean value±standard deviation ×3 of each of slope a and intercept b among the results shown in Table 6-21, the following inequalities are understood as a condition to be satisfied by a suitable electrolytic solution of the present invention.

Y≤AX+B(where 0<X<1, 0<Y, 1.8≤A≤3.4, and 3.5≤B≤4.9)

Y≤3.4X+4.9 (where 0<X<1 and 0<Y)

Y≤1.8X+3.5 (where 0<X<1 and 0<Y)

From the values of the maximum value and the minimum value of each of slope a and intercept b among the results shown in Table 6-21, the following inequalities are understood as a condition to be satisfied by a suitable electrolytic solution of the present invention.

Y≤AX+B(where 0<X<1, 0<Y, 2.1≤A≤2.9, and 3.9≤B≤4.6)

Y≤2.9X+4.6 (where 0<X<1 and 0<Y)

Y≤2.1X+3.9 (where 0<X<1 and 0<Y)

### Evaluation Example 3: DSC Measurement 2

The electrolytic solution of Example 1-1 was placed in a pan made from aluminum, and the pan was sealed. Using an empty sealed pan as a control, differential scanning calorimetry analysis was performed in a nitrogen atmosphere using the temperature program below. As a differential scanning calorimeter, DSC Q2000 (manufactured by TA Instruments) was used.

Temperature Program

Decrease the temperature from room temperature to −75° C. at 5° C./min., and keep the temperature for 10 minutes→increase the temperature to 70° C. at 5° C./min.

The DSC curve during the temperature decrease and during the temperature increase was observed. Also with respect to the electrolytic solution of Example 13-1, differential scanning calorimetry analysis was performed in a similar manner. With respect to both the electrolytic solution of Example 1-1 and the electrolytic solution of Example 13-1, peaks were observed during the temperature decrease and during the temperature increase. The results are shown in Table 7.

TABLE 7

| | Example | |
|---|---|---|
| | 1-1 | Example 13-1 |
| Lithium salt | LiFSA | LiPF₆ |
| Organic solvent | DMC | DMC |
| Y | 5 | 5.31 |
| Lithium salt concentration | 2.04 | 2 |
| (mol/L) | | |
| Temperature of exothermic | around | around −40° C. |
| peak top during temperature | −50° C. | |
| decrease | | |
| Temperature of endothermic | around | around −9° C. and |
| peak top during temperature | −10° C. | around −5° C. |
| increase | | |

From the results shown in Table 7, the electrolytic solution having LiFSA as the lithium salt is considered to be less likely to solidify at low temperature, compared with the electrolytic solution having LiPF₆ as the lithium salt.

### Example A-1

A half-cell using the electrolytic solution of Example 1-3 was produced in the following manner.

An aluminum foil having a diameter of 14 mm, an area of 1.5 cm², and a thickness of 15 μm was used as the working electrode, and a metal lithium foil was used as the counter electrode. As the separator, a glass fiber filter (Whatman GF/F) was used. The working electrode, the counter electrode, the separator, and the electrolytic solution of Example 1-3 were housed in a battery case (CR2032 type coin cell case manufactured by Hohsen Corp.) to form a half-cell. This half-cell was used as a half-cell of Example A-1.

### Example A-2

A half-cell of Example A-2 was produced similarly to the half-cell of Example A-1, except for using the electrolytic solution of Example 1-4.

### Example B-1

A half-cell of Example B-1 was produced similarly to the half-cell of Example A-1, except for using the electrolytic solution of Example 2-3.

### Example B-2

A half-cell of Example B-2 was produced similarly to the half-cell of Example A-1, except for using the electrolytic solution of Example 2-4.

### Example C-1

A half-cell of Example C-1 was produced similarly to the half-cell of Example A-1, except for using the electrolytic solution of Example 3-3.

### Example C-2

A half-cell of Example C-2 was produced similarly to the half-cell of Example A-1, except for using the electrolytic solution of Example 3-4.

Table 8 shows the list of the half-cells above.

TABLE 8

| | Electrolytic | Lithium | Organic | |
|---|---|---|---|---|
| Half-cell | solution | salt | solvent | Y |
| Example A-1 | Example 1-3 | LiFSA | DMC | 6 |
| Example A-2 | Example 1-4 | LiFSA | DMC | 8 |
| Example B-1 | Example 2-3 | LiFSA | EMC | 6 |
| Example B-2 | Example 2-4 | LiFSA | EMC | 8 |
| Example C-1 | Example 3-3 | LiFSA | DEC | 6 |
| Example C-2 | Example 3-4 | LiFSA | DEC | 8 |

### Evaluation Example A: Cyclic Voltammetry Evaluation Using Working Electrode Al

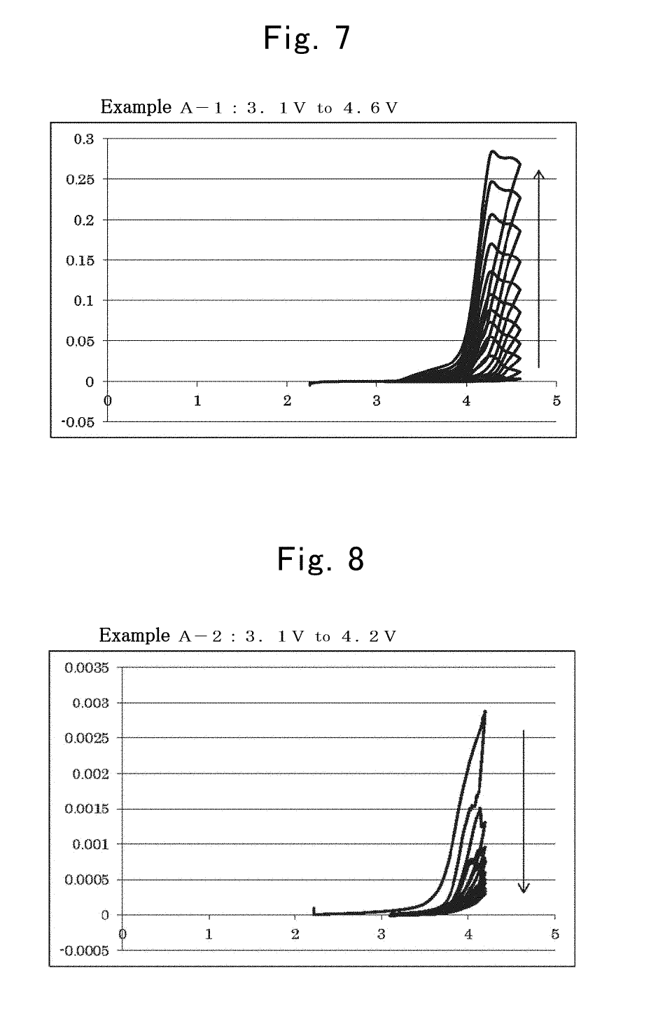

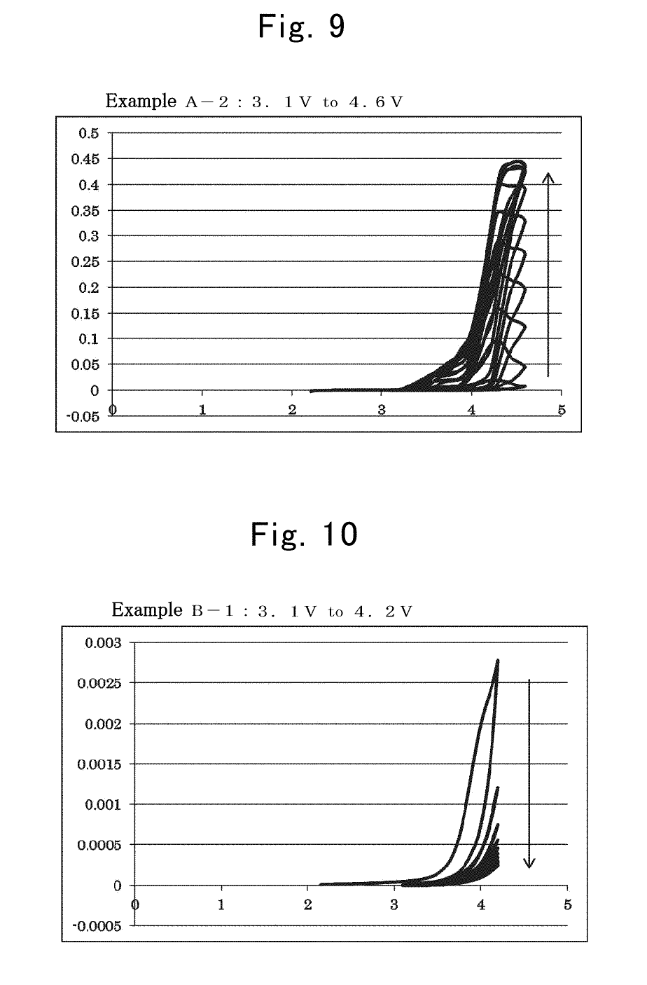

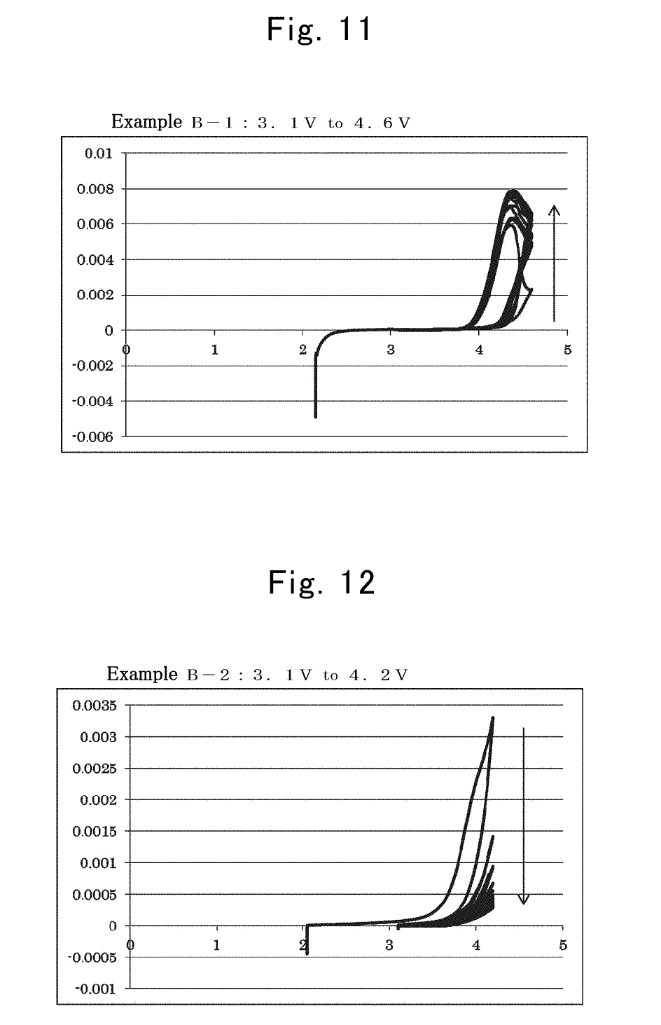

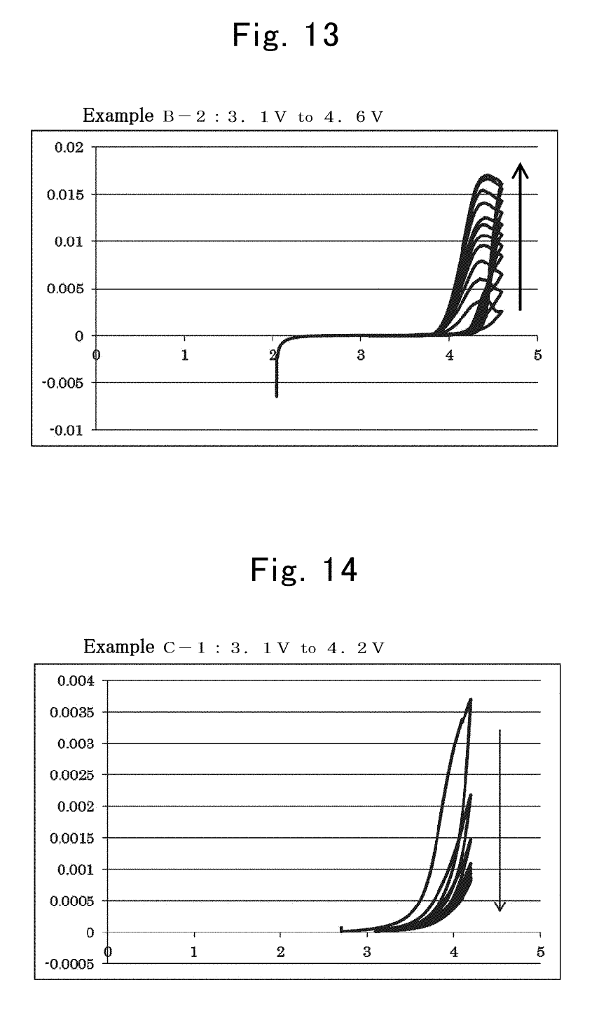

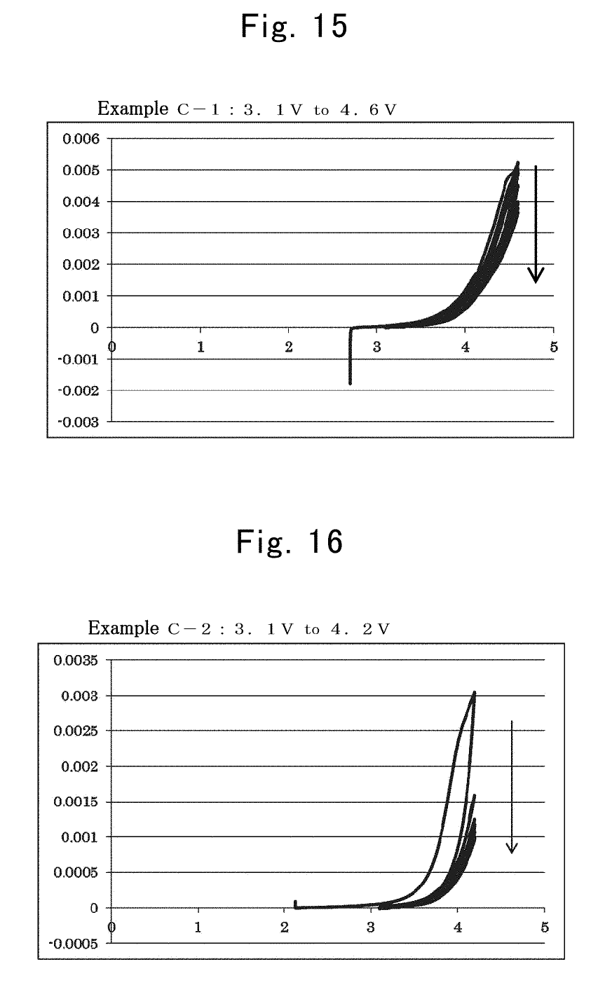

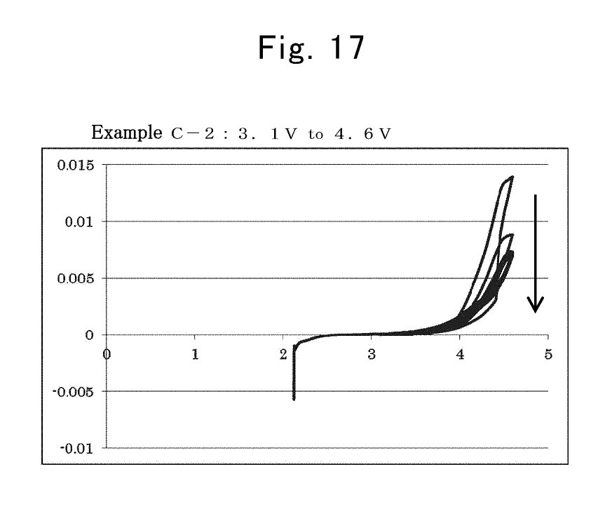

With respect to the half-cells of Example A-1 to Example C-2, 11 cycles of cyclic voltammetry evaluation were performed under a condition of 3.1 V to 4.2 V and 1 mV/s, and then, 11 cycles of cyclic voltammetry evaluation were performed under a condition of 3.1 V to 4.6 V and 1 mV/s. FIG. 6 to FIG. 17 show graphs showing the relationship between potential and response current in the half-cells of Example A-1 to Example C-2. In each figure, the vertical axis represents current (mA), and the horizontal axis represents voltage (V) with respect to the metal lithium. The arrow in each figure shows transit ion of the response current observed whenmultiple cycles are performed.

FIGS. 6, 8, 10, 12, 14, and 16 reveal that, in the cyclic voltammetry in the range of 3.1 V to 4.2 V, current of about 0.003 mA flowed in each half-cell in the first cycle, but the current value of each of all the half-cells decreased in accordance with increase in the number of cycles. In all the half-cells, the response current curve in the oxidation direction and the response current curve in the reduction direction at the 11th cycle substantially matched each other. From these results, in the range of 3.1 V to 4.2 V, corrosion of aluminum of each of the half-cells of Example A-1 to Example C-2 is considered to be suppressed.

When the result of the cyclic voltammetry in the range of 3.1 V to 4.2 V and the result of the cyclic voltammetry in the range of 3.1 V to 4.6 V are compared with each other, the latter is considered to have larger values of response current. As for the increase of the value of response current in each voltage range, Examples A-1 and A-2 each having DMC as the organic solvent had large increase, Examples B-1 and B-2 each having EMC as the organic solvent had small increase, and Examples C-1 and C-2 each having DEC as the organic solvent had smaller increase.

In the cyclic voltammetry in the range of 3.1 V to 4.6 V, the current values of Examples A-1 and A-2 each having DMC as the organic solvent are understood to have increased in accordance with increase in the number of cycles, and the current values of Examples B-1 and B-2 each having EMC as the organic solvent are understood to have slightly increased in accordance with increase in the number of cycles. With respect to these half-cells, even when the number of cycles is increased, occurrence of corrosion reaction of aluminum is suggested. On the other hand, the current value of Examples C-1 and C-2 each having DEC as the organic solvent showed a decreasing tendency in accordance with increase in the number of cycles. Corrosion of aluminum of the half-cells of Examples C-1 and C-2 is considered as being suppressed.

Further, in the cyclic voltammetry in the range of 3.1 V to 4.6 V, the half-cell provided with an electrolytic solution having 6 as Y is understood to have a smaller current value than the half-cell provided with an electrolytic solution having 8 as Y.

From the results described above, in terms of corrosiveness on aluminum, DEC is considered to be most preferable, EMC is considered to be preferable next, and DMC is considered to be preferable next thereto, as the organic solvent of the electrolytic solution of the present invention. As for the value of Y, a smaller value is considered to be more preferable.

When the results of Evaluation Example 1 and Evaluation Example 2 and the result of Evaluation Example A are considered in combination, in order to suitably realize the ionic conductivity and low temperature solidification of the electrolytic solution, and the aluminum corrosiveness in the case of a battery, as for the organic solvent of the electrolytic solution of the present invention, a mixed solvent having DMC as the first heteroelement-containing organic solvent and EMC and/or DEC as the second heteroelement-containing organic solvent is suggested to be suitable, and further, an electrolytic solution of the present invention having a small value of Y is suggested to be more suitable.

### Example I

A lithium ion secondary battery of Example I provided with the electrolytic solution of Example 6-1 was produced in the following manner.

90 parts by mass of Li_{1.1}Ni_{5/10}Co_{3/10}Mn_{2/10}O₂ serving as the positive electrode active material, 8 parts by mass of acetylene black serving as the conductive additive, and 2 parts by mass of polyvinylidene fluoride serving as the binding agent were mixed together. This mixture was dispersed in a proper amount of N-methyl-2-pyrrolidone to make a slurry. As the positive electrode current collector, an aluminum foil having a thickness of 15 μm and corresponding to JIS A1000 series was prepared. The slurry was applied in a film form on a surface of this aluminum foil by using a doctor blade. The aluminum foil on which the slurry was applied was dried for 20 minutes at 80° C. to remove N-methyl-2-pyrrolidone. Then, this aluminum foil was pressed to obtain a joined object. The obtained joined object was heated and dried in a vacuum dryer for 6 hours at 120° C. to obtain an aluminum foil having a positive electrode active material layer formed thereon. This aluminum foil having a positive electrode active material layer formed thereon was used as the positive electrode.

98 parts by mass of graphite as the negative electrode active material, and 1 part by mass of styrene butadiene rubber and 1 part by mass of carboxymethyl cellulose, which both served as the binding agent, were mixed together. This mixture was dispersed in a proper amount of ion exchanged water to make a slurry. As the negative electrode current collector, a copper foil having a thickness of 10 μm was prepared. The slurry was applied in a film form on a surface of the copper foil by using a doctor blade. The copper foil on which the slurry was applied was dried to remove water, and then, the copper foil was pressed to obtain a joined object. The obtained joined object was heated and dried in a vacuum dryer for 6 hours at 100° C. to obtain a copper foil having a negative electrode active material layer formed thereon. This copper foil having a negative electrode active material layer formed thereon was used as the negative electrode.

As the separator, a porous film made from polypropylene and having a thickness of 20 μm was prepared.

An electrode assembly was formed by sandwiching the separator between the positive electrode and the negative electrode. The electrode assembly was covered with a set of two sheets of a laminate film. The laminate film was formed into a bag-like shape by having three sides thereof sealed, and the electrolytic solution of Example 6-1 was poured into the laminate film. Four sides were airtight sealed by sealing the remaining one side to obtain a lithium ion secondary battery in which the electrode assembly and the electrolytic solution were sealed. The obtained lithium ion secondary battery was used as the lithium ion secondary battery of Example I.

### Example II

A lithium ion secondary battery of Example II was produced by a method similar to that in Example I, except for using the electrolytic solution of Example 7-1 as the electrolytic solution.

### Example III

A lithium ion secondary battery of Example III was produced by a method similar to that in Example I, except for using the electrolytic solution of Example 7-2 as the electrolytic solution.

### Example IV

A lithium ion secondary battery of Example IV was produced by a method similar to that in Example I, except for using the electrolytic solution of Example 8-1 as the electrolytic solution.

### Example V

A lithium ion secondary battery of Example V was produced by a method similar to that in Example I, except for using the electrolytic solution of Example 9-2 as the electrolytic solution.

### Example VI

A lithium ion secondary battery of Example VI was produced by a method similar to that in Example I, except for using the electrolytic solution of Example 9-3 as the electrolytic solution.

### Comparative Example I

A lithium ion secondary battery of Comparative Example I was produced by a method similar to that in Example I, except for using the electrolytic solution of Comparative Example 1 as the electrolytic solution.

### Reference Example I

A lithium ion secondary battery of Reference Example I was produced by a method similar to that in Example I, except for using the electrolytic solution of Reference Example 4-1 as the electrolytic solution.

### Reference Example II

A lithium ion secondary battery of Reference Example II was produced by a method similar to that in Example I, except for using the electrolytic solution of Reference Example 5-1 as the electrolytic solution.

### Reference Example III

A lithium ion secondary battery of Reference Example III was produced by a method similar to that in Example I, except for using the electrolytic solution of Reference Example 6-3 as the electrolytic solution.

### Reference Example IV

A lithium ion secondary battery of Reference Example IV was produced by a method similar to that in Example I, except for using the electrolytic solution of Reference Example 7-4 as the electrolytic solution.

### Evaluation Example I: Capacity Retention Rate and Increase Rate of Direct Current Resistance

With respect to the lithium ion secondary batteries of Examples I to VI, Comparative Example I, and Reference Examples I to IV, the following test was performed to evaluate the capacity retention rate and the increase rate of each direct current resistance.

For each of the lithium ion secondary batteries, a charging and discharging cycle of charging up to 4.1 V with a constant current at 1 C rate at a temperature of 60° C., and then discharging down to 3.0 V with a constant current at 1 C rate was repeated by 290 cycles. The capacity retention rate was calculated by the following formula. Capacity retention rate (%)=100×(discharge capacity at 290-th cycle)/(discharge capacity at first cycle)

For each of the lithium ion secondary batteries before and after conducting the 290 cycles of charging and discharging, the temperature was adjusted to 25° C. and the voltage was adjusted to 3.68 V, and then, constant current discharging was performed at 15 C rate for 10 seconds. From the current value and the amount of change in voltage before and after this discharging, the direct current resistance during discharging was calculated according to Ohm's law. The increase rate of direct current resistance during discharging was calculated by the following formula.

Increase rate of direct current resistance during discharging (%)=100×((direct current resistance during discharging in lithium ion secondary battery after 290 cycles of charging and discharging)−(direct current resistance during discharging in lithium ion secondary battery before 290 cycles of charging and discharging))/(direct current resistance during discharging in lithium ion secondary battery before 290 cycles of charging and discharging)

Further, for each of the lithium ion secondary batteries before and after conducting the 290 cycles of charging and discharging, the temperature was adjusted to 25° C. and the voltage was adjusted to 3.68 V, and then, constant current charging was performed at 15 C rate for 10 seconds. From the current value and the amount of change in voltage before and after this charging, the direct current resistance during charging was calculated according to Ohm's law. The increase rate of direct current resistance during charging was calculated by the following formula.

Increase rate of direct current resistance during charging (%)=100×((direct current resistance during charging in lithium ion secondary battery after 290 cycles of charging and discharging)−(direct current resistance during charging in lithium ion secondary battery before 290 cycles of charging and discharging))/(direct current resistance during charging in lithium ion secondary battery before 290 cycles of charging and discharging)

The results are shown in Table 9.

TABLE 9

| | | | | Increase | Increase |
|---|---|---|---|---|---|
| | | | | rate of | rate of |
| | | | | direct | direct |
| | | | | current | current |
| | | | Capacity | resistance | resistance |
| Lithium ion | | | retention | during | during |
| secondary | Electrolytic | | rate | discharging | charging |
| battery | solution | Y | (%) | (%) | (%) |
| Example I | Example 6-1 | 5 | 85.9 | 11 | 10 |
| Example II | Example 7-1 | 5 | 86.4 | 10 | 10 |
| Example III | Example 7-2 | 5.2 | 87.6 | 14 | 13 |
| Example IV | Example 8-1 | 5 | 86.0 | 21 | 20 |
| Example V | Example 9-2 | 5.2 | 85.5 | 17 | 22 |
| Example VI | Example 9-3 | 5.5 | 85.2 | 23 | 21 |
| Comparative | Comparative | 10 | 71.1 | 101 | 92 |
| Example I | Example 1 | | | | |
| Reference | Reference | 4 | 87.5 | 11 | 11 |
| Example I | Example 4-1 | | | | |
| Reference | Reference | 4 | 85.8 | 17 | 16 |
| Example II | Example 5-1 | | | | |
| Reference | Reference | 4.4 | 83.8 | 11 | 10 |
| Example III | Example 6-3 | | | | |
| Reference | Reference | 4.6 | 84.4 | 14 | 14 |
| Example IV | Example 7-4 | | | | |

Each of the lithium ion secondary batteries of Examples is understood to have suitably-retained capacity, compared with the lithium ion secondary battery of Comparative Example I. In addition, each of the lithium ion secondary batteries of Examples is understood to have a significantly-suppressed increase rate of direct current resistance during charging and discharging, compared with the lithium ion secondary battery of Comparative Example I. The excellence of the electrolytic solution of the present invention has been demonstrated.

### Evaluation Example II: Low Temperature Output

With respect to the lithium ion secondary batteries of Examples I to VI, Comparative Example II, and Reference Examples I to IV, the following test was performed to evaluate output at low temperature.

For each of the lithium ion secondary batteries, a charging and discharging cycle of charging up to 4.1 V with a constant current at 1 C rate at a temperature of 60° C., and then discharging down to 3.0 V with a constant current at 1 C rate was repeated by 290 cycles. For each of the lithium ion secondary batteries after 290 cycles of charging and discharging, the voltage was adjusted to 3.53 V and discharging was performed at −40° C. The current and the voltage after 2 seconds from the start of the discharging were measured, and the maximum electric power to be outputted was calculated. The electric power calculation results are shown in Table 10.

TABLE 10

| Lithium ion | Electrolytic | | Electric |
|---|---|---|---|
| secondary battery | solution | Y | power (mW) |
| Example I | Example 6-1 | 5 | 54.3 |
| Example II | Example 7-1 | 5 | 105.7 |
| Example III | Example 7-2 | 5.2 | 77.6 |
| Example IV | Example 8-1 | 5 | 92.2 |
| Example V | Example 9-2 | 5.2 | 99.6 |
| Example VI | Example 9-3 | 5.5 | 95.0 |
| Comparative | Comparative | 10 | 17.2 |
| Example I | Example 1 | | |
| Reference Example I | Reference | 4 | 84.6 |
| | Example 4-1 | | |
| Reference Example | Reference | 4 | 84.3 |
| II | Example 5-1 | | |
| Reference Example | Reference | 4.4 | 102.1 |
| III | Example 6-3 | | |
| Reference Example | Reference | 4.6 | 94.8 |
| IV | Example 7-4 | | |

Each of the lithium ion secondary batteries of Examples is understood to suitably operate at low temperature, compared with the lithium ion secondary battery of Comparative Example I. In particular, the lithium ion secondary batteries of Example II and Example IV to Example VI are considered to be excellent.

### Example VII-1

A lithium ion secondary battery of Example VII-1 was produced by a method similar to that in Example I, except for using the electrolytic solution of Example 9-2 as the electrolytic solution.

### Example VII-2

A lithium ion secondary battery of Example VII-2 was produced by a method similar to that in Example VII-1, except for using the following negative electrode provided with polyvinylidene fluoride as the binding agent.

90 parts by mass of graphite and 10 parts by mass of polyvinylidene fluoride serving as the binding agent, and a proper amount of N-methyl-2-pyrrolidone were mixed to create a slurry. As the negative electrode current collector, a copper foil having a thickness of 10 μm was prepared. The slurry was applied in a film form on a surface of the copper foil by using a doctor blade. The copper foil on which the slurry was applied was dried to remove N-methyl-2-pyrrolidone, and then, the copper foil was pressed to obtain a joined object. The obtained joined object was heated and dried in a vacuum dryer for 6 hours at 120° C. to obtain a copper foil having a negative electrode active material layer formed thereon. This copper foil having a negative electrode active material layer formed thereon was used as the negative electrode.

### Example VIII-1

A lithium ion secondary battery of Example VIII-1 was produced by a method similar to that in Example VII-1, except for using the electrolytic solution of Example 2-3 as the electrolytic solution.

### Example VIII-2

A lithium ion secondary battery of Example VIII-2 was produced by a method similar to that in Example VII-2, except for using the electrolytic solution of Example 2-3 as the electrolytic solution.

### Example IV-1

A lithium ion secondary battery of Example IV-1 was produced by a method similar to that in Example VII-1, except for using the electrolytic solution of Example 12-3 as the electrolytic solution.

### Example IV-2

A lithium ion secondary battery of Example IV-2 was produced by a method similar to that in Example VII-2, except for using the electrolytic solution of Example 12-3 as the electrolytic solution.

### Evaluation Example III: Influence of Binding Agent of Negative Electrode

For each of the lithium ion secondary batteries of Examples VIII-1 to IV-2, the following test was performed to evaluate the capacity retention rate.

For each of the lithium ion secondary batteries, charging was performed up to 4.1 V with a constant current at 0.1 C rate at a temperature of 25° C., the voltage was kept for 1 hour, and then, discharging was performed down to 3.0 V with a constant current at 0.1 C rate, whereby the lithium ion secondary battery was activated.

For each of the lithium ion secondary batteries having been activated, a charging and discharging cycle of charging up to 4.1 V with a constant current at 1 C rate at a temperature of 25° C., keeping the voltage for 2 hours from the start of the charging, then discharging down to 3.0 V with a constant current at 1 C rate, and keeping the voltage for 2 hours from the start of the discharging, was repeated by 28 cycles. The capacity retention rate was calculated by the following formula. Capacity retention rate (%)=100×(charge capacity at 28-th cycle)/(charge capacity at first cycle)

The results are shown in Table 11.

TABLE 11

| Lithium | | | | Binding | |
|---|---|---|---|---|---|
| ion | | | | agent of | Capacity |
| secondary | Electrolytic | Organic | | negative | retention |
| battery | solution | solvent | Y | electrode | rate (%) |
| Example | Example | Mole ratio | 5.2 | SBR | 100.5 |
| VII-1 | 9-2 | of | | CMC | |
| | | DMC:EMC = 5:5 | | | |
| Example | Example | Mole ratio | 5.2 | PVDF | 72.1 |
| VII-2 | 9-2 | of | | | |
| | | DMC:EMC = 5:5 | | | |
| Example | Example | EMC | 6 | SBR | 97.2 |
| VIII-1 | 2-3 | | | CMC | |
| Example | Example | EMC | 6 | PVDF | 69.7 |
| VIII-2 | 2-3 | | | | |
| Example | Example | Mole ratio | 5.5 | SBR | 95.7 |
| IV-1 | 12-3 | of | | CMC | |
| | | DMC:DEC = 6:4 | | | |
| Example | Example | Mole ratio | 5.5 | PVDF | 87.5 |
| IV-2 | 12-3 | of | | | |
| | | DMC:DEC = 6:4 | | | |

The meanings of abbreviations in Table 11 are as follows.

SBR: styrene butadiene rubber

CMC: carboxymethyl cellulose

PVDF: polyvinylidene fluoride

From the results shown in Table 11, the lithium ion secondary battery of the present invention provided with the electrolytic solution of the present invention is considered to have a capacity retention rate varied depending on the type of the binding agent of the negative electrode. If the binding agent of the negative electrode is a polymer having a hydrophilic group, the lithium ion secondary battery of the present invention is considered to exhibit an excellent capacity retention rate.

1. An electrolytic solution containing:
a lithium salt; and
dimethyl carbonate serving as a first heteroelement-containing organic solvent, and ethyl methyl carbonate and/or diethyl carbonate serving as a second heteroelement-containing organic solvent, wherein
a total mole ratio Y of the first heteroelement-containing organic solvent and the second heteroelement-containing organic solvent relative to the lithium salt satisfies 5<Y<8, and
when a mole ratio of the second heteroelement-containing organic solvent relative to total moles of the first heteroelement-containing organic solvent and the second heteroelement-containing organic solvent is defined as X, the mole ratio X and the mole ratio Y satisfy an inequality below
Y≤AX+B (where 1.8≤A≤3.4 and 3.5≤B≤4.9).

2. The electrolytic solution according to claim 1, wherein
the mole ratio Y satisfies 5≤Y≤6.

3. The electrolytic solution according to claim 1, wherein
the mole ratio X and the mole ratio Y satisfy an inequality below
Y≤AX+B (where 2.1≤A≤2.9 and 3.9≤B≤4.6).

4. The electrolytic solution according to claim 1, wherein
the lithium salt contains a lithium salt represented by general formula (1) below by not less than 50 mass % or not less than 50 mole %
(R¹X¹)(R²SO₂)NLi general formula (1)
(R¹ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
R² is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
R¹ and R² optionally bind with each other to form a ring.
X¹ is selected from SO₂, C═O, C═S, R^{a}P═O, R^{b}P═S, S═O, or Si═O.
R^{a} and R^{b} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.
R^{a} and R^{b} each optionally bind with R¹ or R² to form a ring.).

5. The electrolytic solution according to claim 4, wherein
the lithium salt represented by the general formula (1) is represented by general formula (1-1) below
(R³X²)(R⁴SO₂)NLi general formula (1-1)
(R³ and R⁴ are each independently C—HₐF_{b}C_{1c}Br_{d}Iₑ(CN)_{f}(SCN)_{g}(OCN)ₕ.
“n”, “a”, “b”, “c”, “d”, “e”, “f”, “g”, and “h” are each independently an integer not smaller than 0, and satisfy 2n+1=a+b+c+d+e+f+g+h.
R³ and R⁴ optionally bind with each other to form a ring, and, in that case, satisfy 2n=a+b+c+d+e+f+g+h.
X² is selected from SO₂, C═O, C═S, R^{c}P═O, R^{d}P═S, S═O, or Si═O.
R^{c} and R^{d} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.
R^{c} and R^{d} each optionally bind with R³ or R⁴ to form a ring.).

6. The electrolytic solution according to claim 4, wherein
the lithium salt represented by the general formula (1) is represented by general formula (1-2) below
(R⁵SO₂)(R⁶SO₂)NLi general formula (1-2)
(R⁵ and R⁶ are each independently CₙHₐF_{b}Cl_{c}Br_{d}Iₑ
“n”, “a”, “b”, “c”, “d”, and “e” are each independently an integer not smaller than 0, and satisfy 2n+1=a+b+c+d+e.
R⁵ and R⁶ optionally bind with each other to form a ring, and, in that case, satisfy 2n=a+b+c+d+e.).

7. The electrolytic solution according to claim 4, wherein
the lithium salt represented by the general formula (1) is (CF₃SO₂)₂NLi, (FSO₂)₂NLi, (C₂F₅SO₂)₂NLi, FSO₂(CF₃SO₂)NLi, (SO₂CF₂CF₂SO₂)NLi, or (SO₂CF₂CF₂CF₂SO₂)NLi.

8. The electrolytic solution according to claim 1, wherein
relative to an entirety of the heteroelement-containing organic solvent contained in the electrolytic solution, a total of the first heteroelement-containing organic solvent and the second heteroelement-containing organic solvent is not less than 80 vol % or not less than 80 mole %.

9-13. (canceled)

14. The electrolytic solution according to claim 1, wherein
relative to an entirety of the heteroelement-containing organic solvent contained in the electrolytic solution, a total of the first heteroelement-containing organic solvent and the second heteroelement-containing organic solvent is not less than 90 vol % or not less than 90 mole %.

15. A lithium ion secondary battery comprising:
the electrolytic solution according to claim 1;
a positive electrode; and
a negative electrode.

16. The lithium ion secondary battery according to claim 15, wherein
the positive electrode includes, as a positive electrode active material, a lithium composite metal oxide which contains lithium, and a transition metal including nickel, cobalt, and/or manganese.

17. The lithium ion secondary battery according to claim 15, wherein
the positive electrode includes a current collector formed from aluminum.

18. The lithium ion secondary battery according to claim 15, wherein
the negative electrode includes graphite as a negative electrode active material.

19. The lithium ion secondary battery according to claim 15, wherein
the negative electrode includes, as a binding agent, a polymer having a hydrophilic group.
